(19) United States
(12) Patent Application Publication
(10) Pub. No.: US 2002/0157020 A1
(43) Pub. Date: Oct. 24, 2002

(54) Firewall for protecting electronic commerce databases from malicious hackers

(76) Inventor: Coby Royer, University City, MO (US)

Correspondence Address: Coby Royer, 7833 Stanford Avenue, Saint Louis, MO, 63130, US

(21) Appl. No.: 09/838,904

(22) Filed: Apr. 20, 2001

(51) Int. Cl. H04L 9/00

(52) U.S. Cl. 713/201

(57) ABSTRACT

A system and method is described for protecting the core databases from being accessed by malicious hackers who have managed to compromise managers and infrastructure components that support an Internet web site. The system determines whether a particular database query has been generated by the e-commerce application system, or is likely to be part of an attack. The system decides whether to allow the query to proceed, or to reject the query, or to return false data. The system also determines whether to raise an alarm about this condition.

### BACKGROUND OF THE INVENTION

This invention relates to a method and apparatus for protecting computer managers from malicious attacks, in general, and a method and apparatus for protection of database managers, in particular.

It is desirable to protect managers that hold secure data or perform transactions desire from attackers that might cause damage by access to data or transaction capabilities. Protection of databases that are accessed by Internet web managers is especially desired. After an attacker has managed to penetrate or compromise a manager that is used to support an electronic commerce web site, and gain administrative access to it, it is usually quite easy for the attacker to download the contents of the central database used by the system, with potentially disastrous consequences for the company whose data has been stolen.

Many electronic commerce web sites use so-called two-tier architectures. In these architectures, the application system executes on the manager that the web manager is also resident on. The application has to have access to the database and thus, the application has logic that connects to the database. If an attacker is able to compromise the web manager and gain administrative access to it, it is then fairly simple for the attacker to find the database connection string either in the application, or in a configuration file used by the application. Once the attacker has this information, it is simple to connect to the database, run a query that extracts the entire database contents to a file, and transmit that file to another computer on the Internet.

Electronic commerce web sites that use these two-tier architectures rely solely upon the strength of network border defenses, which might include firewalls and devices with capabilities such as screened routing, packet filtering, and intrusion detection. As long as they prevent the attacker from being able to successfully compromise the web manager, they can maintain the confidentiality of their customer data. Unfortunately, it is remarkably hard to completely secure managers.

More sophisticated electronic commerce sites use so-called three-tier architectures. In these architectures, the application system executes on a different manager from the web manager software. In this case, an attacker would have to compromise first the web manager, and then use that as a launching pad to attack and compromise the application manager. This is harder to do, and thus it is generally considered that these architectures are more secure and less susceptible to attacks by malicious hackers.

However, even these three-tier architectures are not impervious to attack. If there is a configuration error in the manager that the application system runs on, it is possible for an attacker to compromise the database manager. Alternatively, if a systems administrator uses the same administrative passwords for both the web manager and the application manager, then it is trivial for an attacker to gain immediate control of the application manager.

Again, electronic commerce web sites that use three-tier architectures are heavily reliant upon the strength of their network border defenses.

As skilled practitioners in the art are aware, there are relatively few techniques that have been identified to help protect an electronic web site from external attackers.

One major method that has been used to harden an electronic commerce web site's network border defenses is the use of network firewalls. Since the idea of firewalls was first expounded, a number of improvements and enhancements have been made to these conventional firewalls. However, the basic idea of firewalls contains surprisingly few features. firewalls restrict the TCP/IP ports that incoming packets may utilize. Additionally, they are usually used to control the TCP/IP ports that outgoing packets may use. If TCP/IP packets using disallowed port numbers are received by the firewall, as well as being dropped, the firewall will generally log the event to a system log (or syslog, for short). By inspecting the contents of the syslog, a firewall administrator can determine whether an electronic commerce web site is, or was, under attack by a malicious hacker. Also, firewalls inspect TCP/IP traffic at the protocol level to ensure that packet-to-packet protocol rules are enforced. Malicious hackers have long been able to forge packets that violate the normal TCP/IP rules and, if the TCP/IP stack of the target computer is vulnerable, to either take control of the target computer or at least to crash it.

FIGS. 1 and 2 depict prior art systems that exemplify the problems. In FIG. 1, a client computer 200 connects directly to a target manager computer 220 via internal network 300. FIG. 2 illustrates one prior art use of a conventional firewall 240 to protect access to a client computer 200 in a wo-tier architecture. A user computer 230, is connected to external network 360, which provides a connection to conventional firewall 240. A so-called “demilitarized zone (DMZ) 370 is a network that connects conventional firewall 240 to client computer 200. Although target manager computer 220 may run a variety of types of manager software such as custom transaction services, directory services, mail services, and news services, manager 220 will typically be a database manager. In this case, client computer 200 contains a database client and web manager, and user computer 230 contains a web browser.

Although conventional firewalls considerably reduce the risk of attack by malicious hackers, they do not remove it. They do prevent an attacker from being able to access remote network services that should not be available outside of the enterprise's own network. However, by definition, firewalls must allow certain types of traffic through. Almost all electronic commerce web sites allow both HTTP and HTTPS traffic through their firewalls. Unfortunately, the HTTP protocol is very flexible and web managers are complex pieces of software, and so there are many attacks that malicious hackers can use directly against the web manager. firewalls are completely unable to detect or prevent these attacks.

A more recent innovation in security methods is the network-based intrusion detection system (IDS). This technology is generally implemented with a network sensor that is configured with its network interface card (NIC) operating in promiscuous mode. The sensor is able to see all network traffic that is passing into and out of the network. Generally, the sensor is programmed to match incoming packets with patterns associated with known attacks. If the sensor detects a match, it will forward all information to a central monitoring station that will alert network administrators, or log details of the attack, or change a router access Control List (ACL) to prevent subsequent traffic from reaching the network.

Again, while network-based intrusion detection systems help reduce the likelihood of attackers being able to successfully compromise a manager, they are not capable of identifying all attacks, for several reasons. First, if an attack is not in the database of attack signatures, then the intrusion detection system will not detect the attack. Second, if a malicious hacker suspects that a network-based intrusion detection system is present, the system itself can be attacked or subverted. Typically, subversion methods involve packet fragmentation, so that the network-based intrusion detection system does not have time to reassemble the packets so that the attack would be evident. attacks on an IDS generally involve attempting to flood the system with forged packets that appear to be characteristic of an attack. The network administrator has to try to determine which of all of these attacks are the decoys and which is the real attack. Third, if HTTPS or another encrypted protocol such as IPSec, is used a network-based intrusion detection system will not be able to detect the attack at all, because the packets will still be encrypted at the point at which it sees them.

One technique that has been described as a tool for securing databases is the use of database extenders. However, while database extenders might be capable of protecting databases against attackers who have basic database access rights, they are not helpful in protecting databases against an attacker who has the same access rights as the legitimate application owner, which is true in the case where an attacker has stolen the access information used by the application. Fundamentally, this is because the e-commerce application needs to be able to fully access the database, regardless of whether the data is a native DBMS type or implemented via an extender. Therefore, database extenders are almost irrelevant in improving database security in this particular case.

Other database related security methods implement multi-role security schemes that have been known to practitioners in the art for at least two decades. Again, these schemes are very helpful in controlling what data one user may access versus the data that a different user may access. However, if the attacker has compromised the user-id of a privileged user, such as that associated with the application system, then these methods are unable to help.

In general, most prior art approaches to improving the security of electronic commerce web sites have focused on hardening the security of the network border of the web site. As described above, these approaches are not usually sufficient to guarantee that a malicious hacker will not be able to penetrate and compromise a web manager that supports such an electronic commerce web site. If the attacker does manage to so compromise the manager, then it is generally quite easy for him to find the connection to the core database, extract its contents and copy it to another location on the Internet.

One reason for this is because there is a natural asymmetry at work. The system administrators of the web site have to identify and close every single possible security exposure that may exist in the technology that they are using. Moreover, in many cases, new security exposures are announced by technology vendors on a frequent basis—often weekly—and so systems administrators have to keep their system completely up-to-date in order to be safe from malicious hackers. On the other hand, the attacker only has to find a single weakness in a site to be able to compromise it. Worse, malicious hackers often have a great deal of time to devote to attacking a single web site. Against that, system administrators are often over-committed, and barely have enough time to complete the basic administration functions needed to keep the site functioning, let alone secure.

Prior art attempts to secure electronic commerce web sites focus on hardening the network boundaries, of such a web site. However, if an attacker manages to compromise a manager within such a web site, then it is generally easy for the attacker to extract the contents of the core database and download it to another location on the Internet. This action would constitute a catastrophic loss of customer confidentiality to almost all companies.

It is one object of the invention to stop attackers from being able to download core e-commerce databases even when at least some of the managers that make up the web site have compromised and the attacker would otherwise succeed.

It is another object of the invention to provide such companies with warnings that an attack is actually in progress, and to give options for dealing with such an intrusion.

It is a further object of the invention to allow companies to inventory all of the database queries used by an application system, which is a useful function to system developers and database administrators.

### SUMMARY OF THE INVENTION

These and other objects of the invention are achideved by a system and method in accordance with the invention.

A firewall in accordance with the principles of the invention recognizes that an attacker may succeed in compromising a site's production managers, and protects core database from the attacker. In accordance with the present invention, a firewall system intercepts all commands sent to a manager such as a database manager, and detects and identifies invalid commands. Invalid commands are those that presumably have been issued by a malicious attacker, and do not originate from a legitimate source.

In accordance with the principles of the invention, a method for intercepting each command sent to a manager program generated by a client program and determining whether said command is characteristic of a normal application program, comprises intercepting the command, and preventing direct sending of the command from the client program to the manager program. An analysis is performed upon each command. The command is sent to the manager program if the analysis determines that said command is characteristic of a normal application program. The command is prevented from reaching the manager program if the analysis determines that the command is not characteristic of a normal application program. With this method the manager program is protected from commands that are sent from a client program that is under control of an attacker.

In accordance with one aspect of the invention an administrator is alerted via a notification channel if the analysis determines that the command is not characteristic of a normal application program.

In accordance with another aspect of the invention attacker patterns that correspond to commands generated by a client program that is under control of an attacker are stored. The analysis determines whether or not the command corresponds to one of the stored attacker patterns.

An application firewall program in accordance with the invention intercepts each command sent from a client program to a manager program and determines whether the command is characteristic of a normal application program. The program includes a step to prevent the direct sending of commands from said client program to said manager program. An analysis step determines if the command is characteristic of a normal application program. A forwarding step is provided for sending each command to the manager program if analysis determines that the command is characteristic of a normal program; and

a prevention step in which commands that are not characteristic of a normal application program are prevented from reaching said manager program.

An application firewall machine in accordance with the invention includes a first network interface coupling the firewall machine to a client computer via a first network segment and a second network interface coupling said firewall machine to a manager computer via a second network segment. A communications manager coupled to the first and second network interfaces is operable to read and write data to the first and second network segments via the corresponding first and second network interfaces. The communications manager is further operable to not permit direct passage of network communications across the network interfaces, and operable to send data to the manager computer when analysis determines that data coming from a client computer contains a command that is characteristic of a normal program. A command processor processes the data to identify commands that are being passed as requests from a client computer to the manager computer. A command analyzer analyzes the commands to determine if the commands are characteristic of a normal application program.

### BRIEF DESCRIPTION OF THE DRAWING

The invention will be better understood from a reading of the following detailed description in conjunction with the drawing in which like reference designations are used to identify like elements in the various drawing figures, and in which:

FIG. 1 is a block diagram of a prior art client computer and target manager computer arrangement;

FIG. 2 is a block diagram of a prior art firewall configuration;.

FIG. 3 is a block diagram of a first arrangement in accordance with the principles of the invention;

FIG. 4 is a block diagram of a second arrangement in accordance with the principles of the invention;

FIG. 5 is a block diagram of another embodiment of the invention;

FIG. 6 is a block diagram of yet another embodiment of the invention;

FIG. 7 is a block diagram of a further embodiment of the invention;

FIG. 8 is a block diagram of yet a further embodiment of the invention;

FIG. 9 identifies computer programs running on each machine in the block diagram of FIG. 5;

FIG. 10 illustrates communications between computer programs running on each machine in the embodiments shown in FIGS. 4, 5, and 9;

FIG. 11 illustrates software components and inter-communications in the firewall System of FIG. 10;

FIG. 12 illustrates details of software components and intercommunications in the Action subsystem of FIG. 11;

FIG. 13 is a block diagram showing details of the communications manager of FIG. 12, depicting the client using the native database library in the specific preferred embodiment.

FIG. 14 is a block diagram showing details of the communications manager of FIG. 12;

FIG. 15 is a block diagram of the administration subsystem of FIG. 11;

FIG. 16 is a block diagram of the alert subsystem of FIG. 11;

FIG. 17 is a flowchart of initialization and termination functions;

FIGS. 18, 19 and 20 are flowcharts of the dependent threads in a system in accordance with the invention;.

FIG. 21 is a flowchart of the Action subsystem of FIG. 12 when operating in a learning mode;

FIG. 22 is a flowchart of the Action subsystem of FIG. 12 when operating in an Alarm mode;

FIG. 23 is a flowchart of the alerting interface of FIG. 16;

FIGS. 24 and 25 are flowcharts of the administration subsystem of FIG. 15.

### DETAILED DESCRIPTION

The invention of the illustrative embodiments described herein serves both to protect manager programs from activities of client programs as well as to protect manager computers against client computers. The invention as implemented in the illustrative embodiments comprises software as well as a computer or system on which that software runs.

In the following detailed description of the illustrative embodiments, numerous specific details are set forth in order to provide a thorough understanding of the present invention. It will be apparent to those skilled in the art that other embodiments need not utilize all the specific details to practice the invention. Certain well known structures, interfaces and processes (for example, SNMP & SMTP formatters) are not shown for purposes of clarity.

Within this description, references to attackers and hackers, and the attacks in which they engage, are often described as malicious. The use of this terminology is not intended to limit the scope of the invention. In fact, an attack might or might not be demonstrably malicious, as the intentions of the perpetrator are irrelevant to the invention. The invention detects and prevents activities which are other than what is intended by the designers and implementers of the systems being protected. Furthermore, the use of the terms attacker and hacker should not be construed to refer only to an human that engages some type of attack. Rather, attacker and hacker may refer to a human, computer, software, or other entity which attempts to carry out activities that are other than what is intended by the designers and implementers of the systems protected by the invention.

Generally, relational databases that support electronic commerce systems are vulnerable to being attacked by malicious hackers. In all e-commerce implementations, the application program that is part of the electronic commerce system will use a database connection, such as an ODBC, JDBC or native database connection (such as ADO, for Microsoft SQL server, for example), in order to access the database. As such, the application program is typically referred to as a client of that database, and is called a client program. If an attacker is able to compromise the manager on which the database access portions execute, then the attacker will inevitably be able to gain use of the connection used by the application. As any database access requests (whether SQL queries, or other) executed by the attacker will run with the same privileges as the application, then the entire contents of the database may generally be downloaded by the attacker. Similarly, attackers may attempt to modify or delete data from the database. Furthermore, attackers may seek to execute transactions that result in other damages such as fraudulent financial transactions.

The phrase, “normal application program”, denotes software and software components on a computer in an e-commerce system that is not under the control of an attacker. Application programs that are under the control of an attacker, as well as application programs, software components, and other objects that are introduced by an attacker in order to compromise a manager, are considered not to be normal application programs, as detection and prevention of their behavior is an objective of the invention.

The principles and architecture that allow a firewall system in accordance with the invention to inspect database commands destined for a database manager can similarly be applied to other types of commands destined for other types of managers. The embodiments described characterize construction of a system and method for protecting databases. The principles of the invention are not constrained to database protection. As used herein, the term “command” is nearly synonymous with “request.” A command is considered to be a well characterized request from a client to a manager, having a specific, pre-defined, syntax and often containing parameters.

The invention protects against the threats described above by detecting manager access behavior that is different from characteristic of normal manager access behavior. The invention protects against threats by detecting database access behavior that is different from behavior generated by the database client program that normally accesses it, especially the behavior of an e-commerce application that normally accesses the database. The vast majority of applications have extremely predictable database access behavior, with regard to the number of database connections, the type and sequence of queries generated, and the exact syntax of the queries. When the invention detects queries that exhibit behavior that is a typical of the application, it generates alerts to the system administrator and takes predefined actions. Usually, the default predefined action will prevent the suspicious query from being executed by the database management system (DBMS).

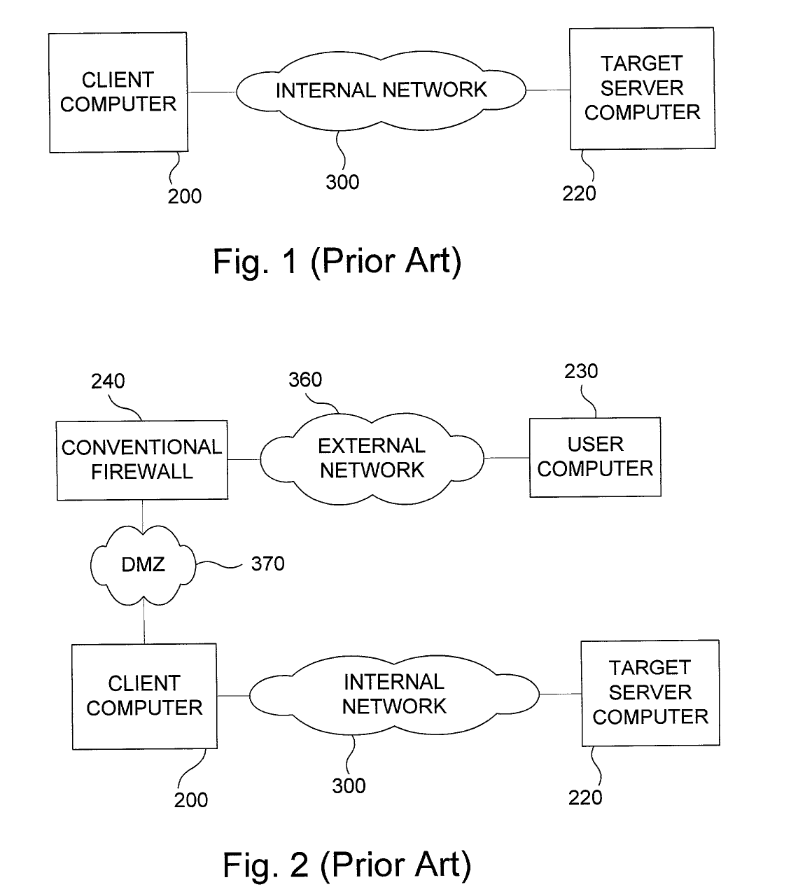

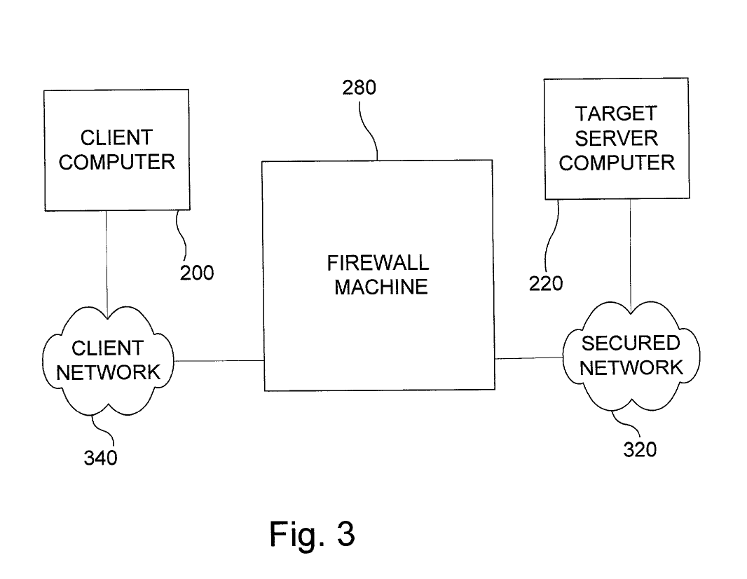

In a system in accordance with the principles of the invention as shown in FIG. 3, a firewall machine 280 protects a target manager or server computer 220 from a computer 200. This differs from the prior art system of FIG. 1 in that internal network 300 is split into two separate networks: client network 340 and secured network 320. Client computer 200 is presumably accessed directly by other user computers, where there exists the possibility that these users are attackers. If an attacker gains control of client computer 200, the attacker may proceed to attack the target manager computer 220, which is protected by the interposing firewall machine 280.

Firewall machine 280 of FIG. 3 may be used in combination with conventional firewall devices and/or in a variety of network topologies. For example, although not shown in the figures, certain connections of machines shown in the prior art arrangement of FIG. 2 might provide a user computer with access to the client computer in a two-tier architecture that contains a conventional firewall. Specifically, user computer 230 may be connected to an external network 360, providing a connection to conventional firewall 240, which connects to client computer 200 via demilitarized zone (DMZ) 370. The invention is equally applicable to a three-tier architecture.

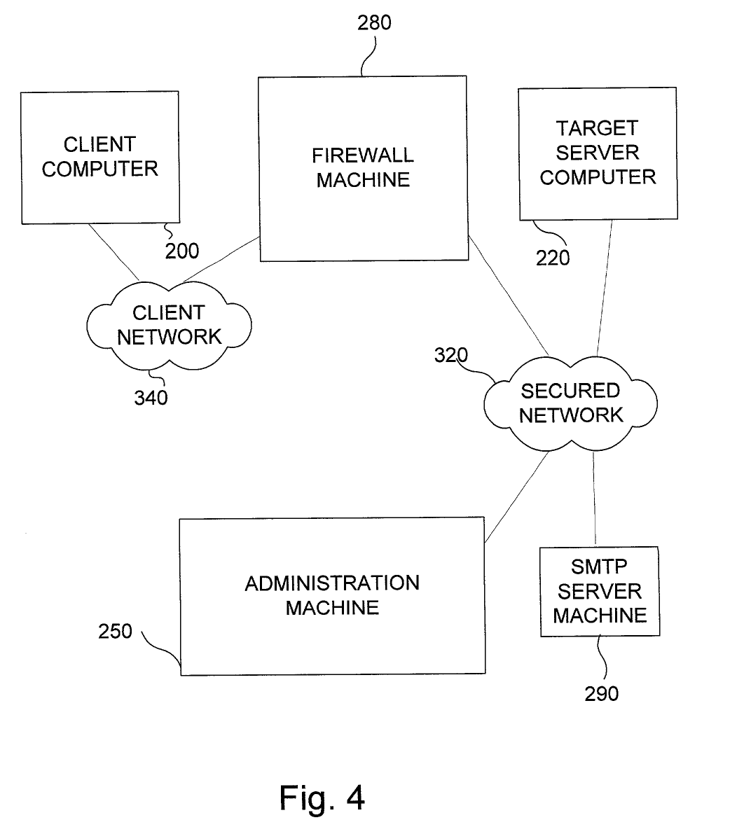

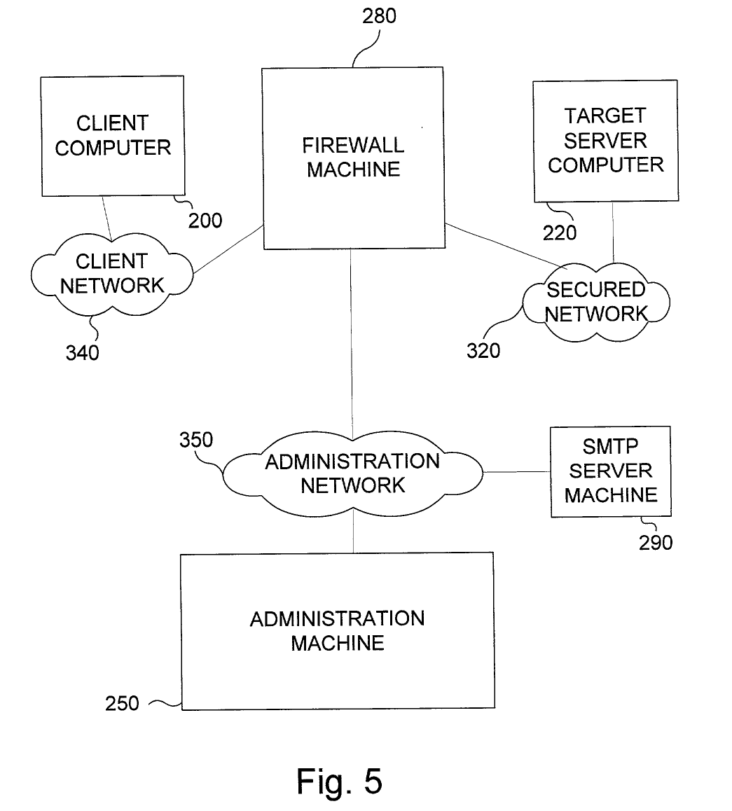

In one embodiment of the invention, additional machines support administration and alerting. FIG. 4 illustrates an embodiment of the invention utilizing an SMTP manager or server machine 290 to handle administrator e-mail alerts and an administration machine 250 that provides means for administrators to administer the firewall. The embodiment of FIG. 5 uses the same set of machines, but places SMTP manager machine 290 and administration machine 250 on a separate administration network 350. In alternative embodiments administration machine 250 and SMTP manager machine 290 may be placed in other network segments. The exact configuration of network segments within a given data center may vary somewhat from that shown. For example, SMTP manager machine 290 and administration machine 250 could be the same physical machine. Alternative embodiments may also omit either the administration machine 250 or SMTP manager machine 290, or may omit both as depicted in FIG. 3.

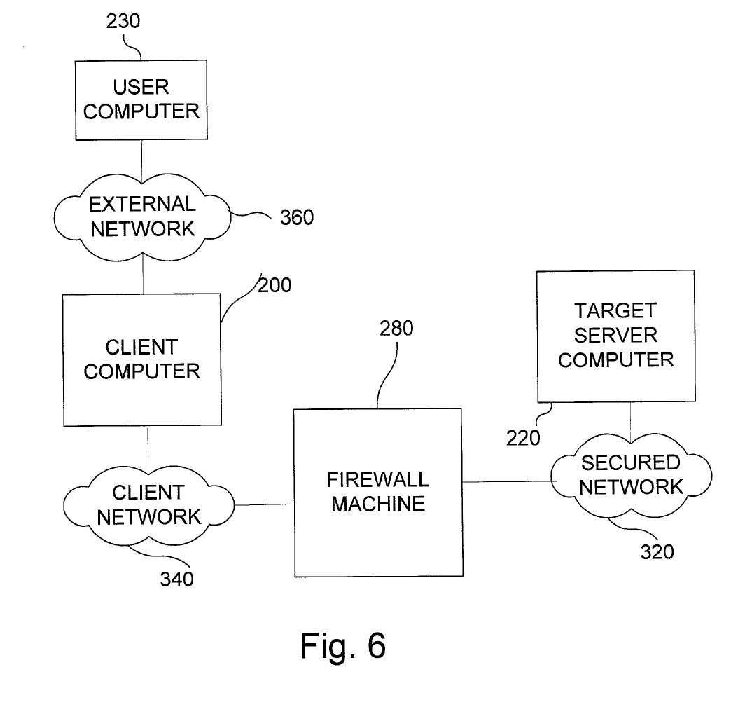

In the two-tier architecture depicted in FIG. 6, user computer 230 connects to the client computer 200 via external network 360.

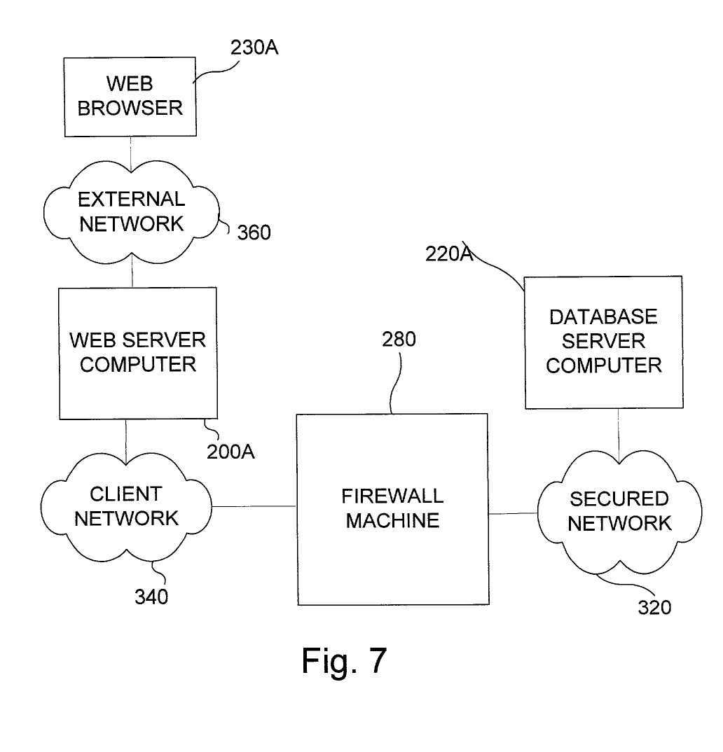

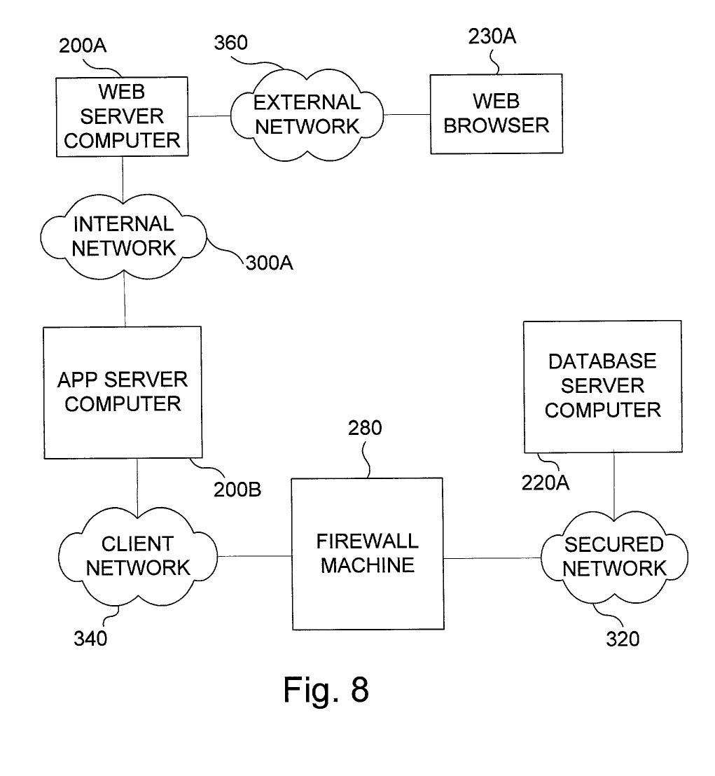

In the embodiments shown in FIGS. 7 and 8 a firewall protects database managers from attack. In FIGS. 7 and 8, database manager computer 220A is the specific equivalent to target manager computer 220 of FIG. 6. FIG. 7 shows a two-tier architecture. Web manager computer 200A is the specific equivalent of client computer 200 of FIG. 6.

FIG. 8, depicts a three-tier architecture in which application manager computer 200B is equivalent to general client computer 200 of FIG. 6. FIG. 8 depicts web manager or server computer 200A. Web server or manager computer 200A runs web browser 230A, internal network 300A, and external network 360, that are characteristic of the three-tier web architecture. External network 360 depicted in FIGS. 6, 7 and 8 would typically be the Internet, but may also be an intranet, extranet, or other network. Details of administration and alerting are omitted for clarity in FIGS. 6, 7 and 8.

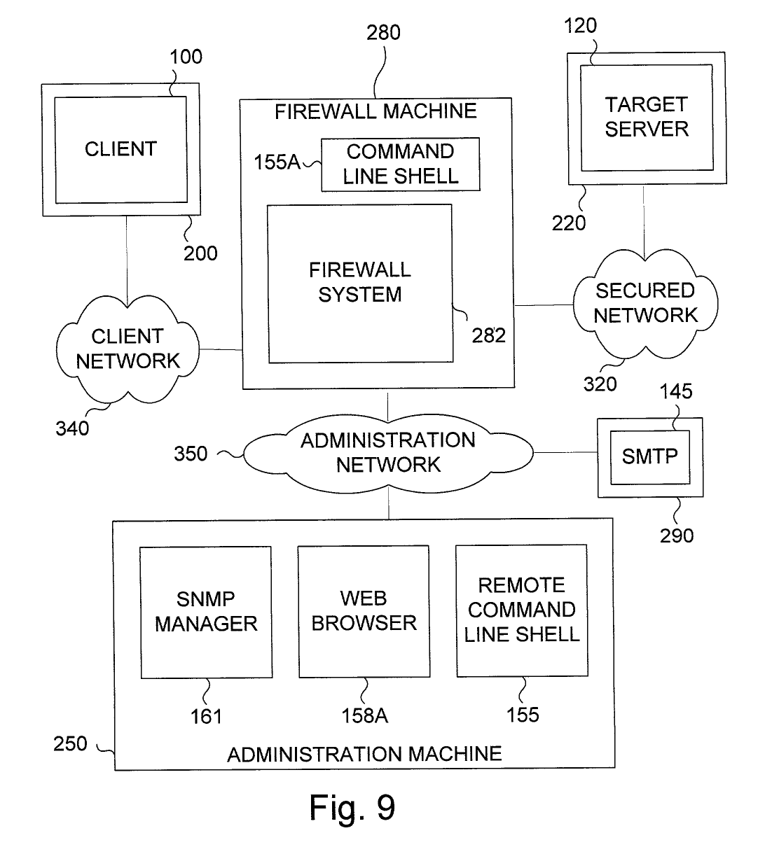

FIG. 9 depicts details of computer programs that run within the machines depicted in previous figures. It shows the general preferred embodiment as previously presented in FIG. 5. Client computer 200 contains client 100, which is a computer program that accesses target server 120, running on target server computer 220. Firewall system 282, is a software program that runs on firewall machine 280. This software may comprise a number of separate files containing source code, libraries, data, configuration files, and databases used by the system. Firewall machine 280 runs an appropriate operating system such as Linux. The operating system is configured so that the software runs and can access system resources such as network communications interfaces, shared libraries, and application programming interfaces (APIs).

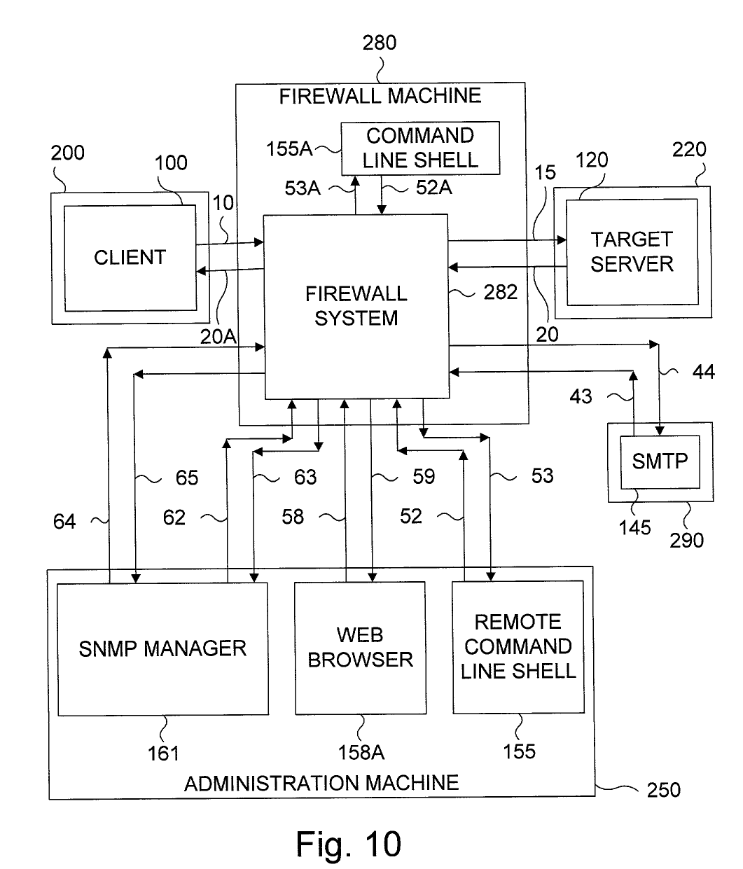

Numerous programs support administration. Command line shell 155A allows the administrator to enter commands from within a text-based shell or console on the firewall machine 280 as shown in FIG. 10. Alternatively, the administrator may use a plurality of programs that are contained on administration machine 250. These include a simple network management protocol (SNMP) manager 161, web browser 158A, and remote command line shell 155. SNMP manager 161 may also be used to alert administrators of attacks. Although an administrator is typically a human user of computer systems, the term administrator may also include other agents such as software, hardware, and other systems that have the ability to interact with the invention to observe or control its behavior in a manner analogous to the human administrator.

In alternate embodiments the software programs shown in FIGS. 9 and 10 may reside on other machines. For example, data centers may choose to use a centralized SNMP manager that controls and monitors machines unrelated to my invention, such as network components and manager software. Web browsers might exist on a plurality of machines, including the firewall machine 280. They might also access the firewall via networks and network components not shown in FIG. 9. Other administration programs are also possible, such as a graphical user interface (GUI) on a client program, which is not shown.

An SMTP server 145 provides e-mail capabilities to be used for notifying administrators when an attack occurs. This is depicted running on SMTP manager machine 290 in FIG. 9. This manager can run on different machines under alternative embodiments. It may also be absent in alternative embodiments. Depending upon the network configuration of the specific environment where the invention is deployed, additional networks and computers will be present. For example, e-mail messages may be forwarded by SMTP server 145 on SMTP manager machine 290 to other SMTP managers on other machines. In order for the message to be received by the intended recipient, a POP or LDAP manager must also be used by the administrator to retrieve such forwarded e-mail messages. Generation of e-mail messages may also be used as a means of sending a wireless beeper page via an appropriate system. Although not shown in the figures, other types of alert notification machines and programs can be utilized. For example, the firewall system might communicate with a beeper paging system not based on e-mail.

The software can be provided in binary form as a product to those who wish to install it onto machines of their own choosing. The descriptions of software components is intended to apply not only to a specific machine such as the firewall, but also wherein the software is installed onto arbitrary machines.

As shown in FIG. 10, the invention comprises a collection of intercommunicating software programs, including firewall system 282 that protects a target server 120 from commands that are generated by a client 100, which might or might not be controlled by a malicious hacker. FIG. 10 depicts details of communications between software programs for machines shown in FIGS. 4, 5 and 9.

FIG. 10 and subsequent block diagrams depict communication pathways and are labeled with the information that flows across these pathways. Pathways between software components residing on different physical machines utilize network communications with a networking layer such as sockets-layer communication over TCP/IP as well as protocols built using the networking layer. These protocols include but are not limited to native database protocols such as that used by Oracle database from Oracle Corporation of Redwood City, Calif., as well as HTTP, telnet, SNMP, SMTP, remote Procedure Calls (RPC), and remote method invocation (RMI). Pathways between software components residing on the same physical machines communicate by reading and writing of shared memory, and/or parameter passage and result return from invocation of function and function call-backs, or may use the same pathways as is described for software components residing on different physical machines.

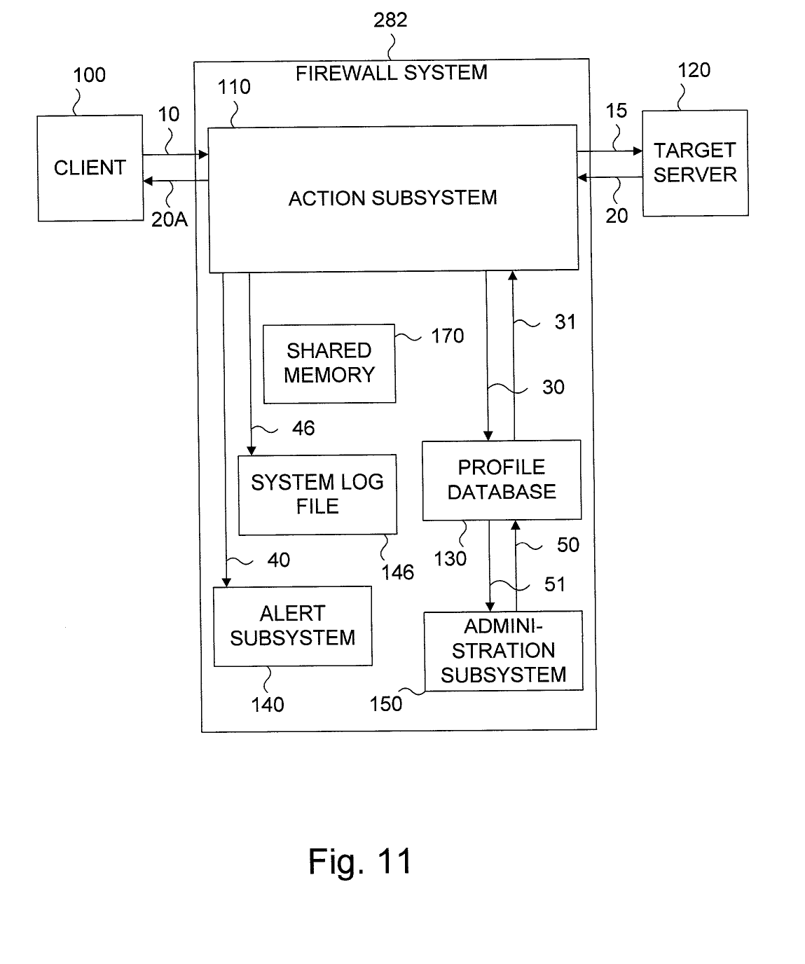

As shown in FIGS. 10, 11, 12, 13 and 14, the action of the system is determined by the response of action subsystem 110 to an Incoming Command 10 using previous command patterns stored in a profile database 130. As shown in FIG. 11, if an incoming command 10 is seen by action subsystem 110 that does not exist in the profile database 130, then the system asserts that an attack is in progress.

Administration subsystem 150 is used to control operation of the system. Alert subsystem 140 reports when an attack is detected, both as shown in FIG. 11.

Firewall system 282 is programmed as a multi-threaded program. Shared memory 170 is used to assist communication between various threads of execution. Other processing models use kernel processes and means for inter-process communications in addition to shared memory, including but not limited to, pipes, message queues, and semaphores.

In the normal event that an attack is not in progress, incoming command 10 is passed through action subsystem 110 and passed to target server 120 as a filtered command 15. A result 20 is returned from the target server 120, passed through action subsystem 110 and returned to client 100 as a result 20A.

In the event that an attack appears to be in progress, command and attack data 40 describing the attack is passed from action subsystem 110 to alert subsystem 140.

Profile database 130 stores data that controls the operation of the system. A profile query 30 is passed to profile database 130 to determine if a particular incoming command 10 has been seen by the firewall system 282 as part of the normal operation of the client 100. A profile result set 31 is returned to action subsystem 110. Administration subsystem 150 is used by systems administrators to manage the system. Specifically, it generates an admin query 50 which is passed to the profile database 130, which will return an admin result set 51.

Other embodiments lack profile database 130. Profile database 130 permanently stores information such that it can later be retrieved. An alternative for storage of command data is to employ a system that places the data directly into a computer program that is compiled before deployment. Regardless of whether an actual database is used as depicted by profile database 130, the system will require storage for various types of data, and the functionality associated with reading and writing this data may be referred to as a “storage manager”. The storage manager may be a SQL database manager, an indexed file system storage, a file system storage, or a distributed file system storage, such as network file system (NFS) from Sun Microsystems Inc. of Mountainview, Calif.

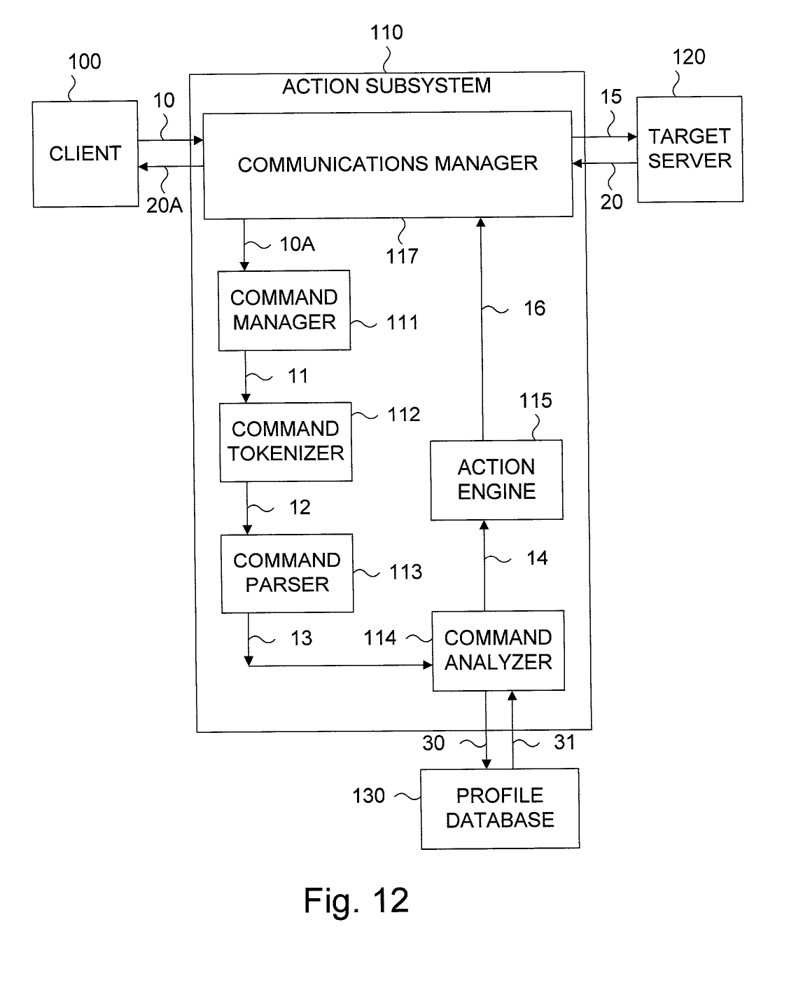

As shown in FIG. 12, action subsystem 110 consists of several subcomponents. Command manager 111 acts as the interface point for client commands and receives an incoming command 10A. Command manager 111 passes an Intermediate command 11 to a command tokenizer 112 which prepares it for processing by breaking it down into discrete language elements of the specific language used in communication between the client 100 and target server 120. The language is a database language such as Structured query Language (SQL). Alternative embodiments may use extensions to SQL, as may be employed by various database vendor implementations or application-specific grammars that convey requests for transactional processing or other capabilities afforded by target server 120.

A tokenized command 12 is passed to a command parser 113. Output from command parser 113, a Parsed command 13, is passed to a command analyzer 114. Command analyzer 114 sends a profile query 30 to profile database 130, which returns a profile result set 31. Command analyzer 114 forwards command analysis 14 to an action engine 115. Based on this command analysis 14, action engine 115 may or may not send a command request 16 to the communications manager 117 for it to send a filtered command 15 to the target server 120. If it does, a result 20 will be returned, which will then be passed back to the client 100, as a result 20A.

Command manager 111, command tokenizer 112, and command parser 113 work together as a command processor to identify incoming commands 10 that are passed from client 100 to target server 120.

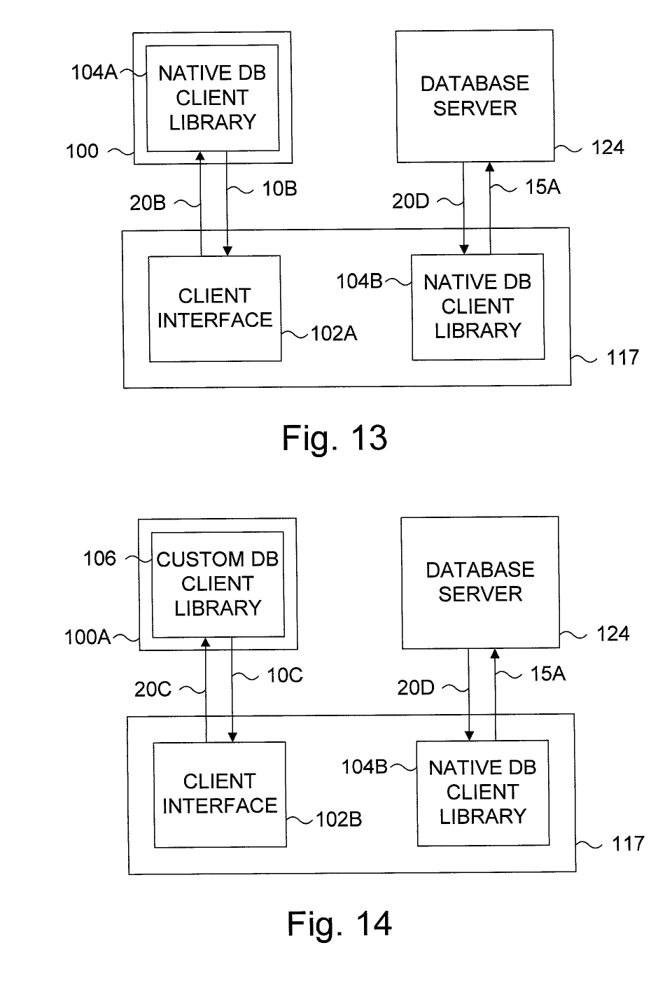

Incoming command 10, incoming command 10A, and filtered command 15 are database commands such as database queries. Result 20 and result 20A are database result sets. This is shown, in part, in FIG. 13 in which result 20A is specifically represented as result set 20B. Command 10 is specific Incoming database command 10B, which will typically be a query. General result 20 is specific result set 20D. General filtered command 15 becomes specific filtered database command 15A.

When a database command or query is received as an Incoming database command 10B, the origin of the command will typically be a native database client library 104A, which is invoked within the client 100 as shown in FIG. 13. Communications manager 117 receives the request as one or more TCP/IP packets, which are processed by client interface 102A that it contains. Client interface 102A is able to use the TCP/IP protocol stack so as to reassemble the database command, regardless of how it is distributed across TCP/IP packets, and without regard for handshaking, error detection, and error correction that are part of the TCP/IP protocol and protocol stack. Client interface 102A behaves in an analogous fashion for the return of results and result sets that comprise the result set 20B. As such, client interface 102A effectively emulates the behavior of a database manager. From the perspective of client 100 under normal operation, there is no apparent difference between communication with an actual database server 124 as per prior art and communication with firewall system 282 of the invention, except possibly for delays in the return of database results. Of course, during detection of an attack client 100 will not receive a result set 20B, which distinguishes the invention from prior art and is a primary operating principle of the invention. Client interface 102A is the interface in what is typically called a protocol endpoint or application proxy in the accepted industry vernacular.

No modification to client 100 is required in order to benefit from use of the invention. An alternative embodiment shown in part by FIG. 14, requires modification of client 100 to create client 100A. Client 100A uses custom database client library 106 instead of native database client library 104A. For example, custom database client library 106 might be implemented as a Java JDBC manager. Although custom database client library 106 would provide the same functionality as native library 104A, it would be implemented as a different software component used within client 100A. It might or might not have the same application Programming interface (API) as native library 104A. In this alternative embodiment, custom database client library 106 communicates with client interface 102B in a fashion similar to the embodiment already described, however, the specific protocol differs, even though the basic messaging is the same. For example, native Oracle protocol or Java RMI may be used. Both protocols will pass database commands that appear essentially the same from the perspective of those who write the software that comprises client 100 and client 100A. FIG. 14 depicts the alternative protocol by designating the Incoming database command 10C and result set 20C.

Both embodiments of FIG. 13 and FIG. 14 utilize native database client library 104B to exchange filtered database command 15A and result set 20D with database server 124. Although the embodiments differ in the specific client interfaces that comprise communications manager 117, both embodiments use exactly the same native database client library 104B. Note that this is also the same type, although not instance, as is part of client 100 and depicted as native database client library 104A in FIG. 13.

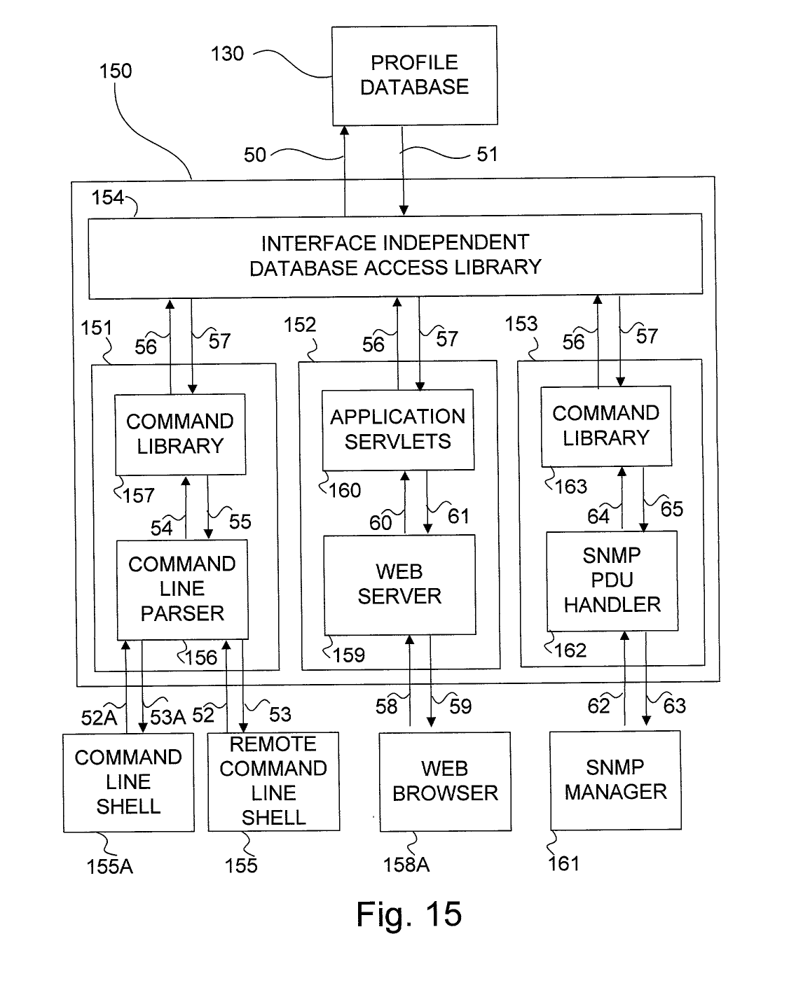

As shown in FIG. 15, administration subsystem 150 includes: a command line interface 151, a graphical user interface 152, and an SNMP interface 153. There are many different ways in which an administrative interface to a system could be built such as with configuration files, thick-client client/manager implementations among others. Likewise other interfaces may be used.

Command line interface 151 communicates with a remote command line shell 155 or command line shell 155A. These shells run as operating system shells or consoles. Shell parameters 52 or 52A are passed into command line parser 156, and a textual output 53 or 53A is returned. Command line interface 151 contains network capabilities that allow it to communicate with remote command line shell 155. Command line parser 156, processes the command entered by the user, determines which administrative action should take place, and sends a command request 54 to command library 157. Responses are passed back as a command result 55. In turn, command library 157 formats a profile access request 56 and sends it to interface Independent database access library 154. Interface Independent database access library 154 formats an admin query 50 and passes it to profile database 130, and the results are returned in an admin result set 51. Interface independent database access library 154 reformats the result and passes it back, as a profile access response 57. Command library 157 passes the response back to command line parser 156 as a command result 55, which in turn is passed to the appropriate shell as text output.

Graphical user interface 152 is implemented as a multi-tier thin-client HTML interface. Web browser 158A, operated by the system administrator, formats an HTTP request 58 and passes it to web server 159, which may be a commercial product such as Internet Information Server (IIS) from Microsoft Corporation of Redmond, Wash., or Apache. An HTML Page 59 is returned to the web browser 158A. Web server 159 invokes application code implemented as one or more java application servlets 160, passing them invocation parameters 60. Java application servlet 160 will return a formatted response 61 to web server 159. Java application servlet 160 will format a profile access request 56 and send it to interface independent database access library 154. Interface independent database access library 154 formats an admin query 50 and passes it to profile database 130, and the results are returned in an admin result set 51. Interface Independent database access library 154 reformats the result and passes it back, as a profile access response 57. Application servlets 160 format the results into a web page and send the page to web browser 158A via web server 159.

SNMP interface 153 is a conventional SNMP implementation, and allows firewall system 282 to communicate with SNMP manager 161 which is a commercial product such as HP/Openview, a product of Hewlett Packard Corporation, or CA-Unicenter, a product of computer Associates, of Islandia, N.Y. SNMP manager 161 passes an SNMP PDU 62 to SNMP PDU handier 162. A formatted SNMP response 63 is later returned to SNMP manager 161. SNMP PDU handler 162 formats an SNMP command request 64 and sends it to SNMP command library 163. SNMP command library 163 will later return an SNMP command result 65. SNMP command library 163 will format a profile access request 56 and send it to interface independent database access library 154. Interface independent database access library 154 formats an admin query 50 and passes it to profile database 130, and the results are returned in an admin result set 51. Interface Independent database access library 154 reformats the result and passes it back, as a profile access response 57. Command library 163 passes the response back to SNMP PDU handler 162 as an SNMP command result 65, which in turn is passed to SNMP manager 161.

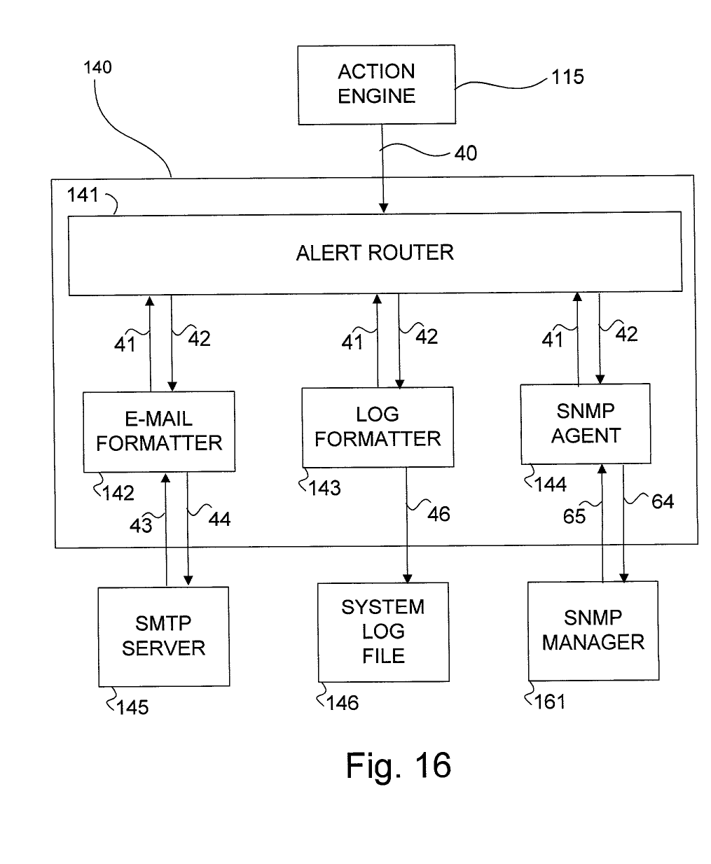

As shown in FIG. 16, alert subsystem 140 comprises several subcomponents that support different means of sending alerts. Alert router 141 is responsible for determining, based on the information passed in the command and attack data 40 by action engine 115, which individual formatters will be passed the data. Three alerting formatters are shown: an E-mail formatter 142, a system log formatter 143, and an SNMP agent 144. There are several other formatters that are both practical and desirable which are not described herein. Such additional formatters do not change the nature of the invention.

E-mail formatter 142 is responsible for formatting e-mail messages, generally in the SMTP format, to be-sent to systems administrators. Often, although these messages will be formatted as SMTP messages, they will in fact be sent to destinations that are mobile devices such as pagers, cellular phones, Personal Digital Assistants (PDAs), etc. E-mail formatter 142 receives alert message data 42 from alert router 141. It reformats this data as an SMTP message 44, and sends it to SMTP server 145. SMTP server 145 would typically be a commercial mail manager product, such as SendMail (from many vendors), QMail, Exchange from Microsoft Corporation, Lotus Notes from Lotus Corporation, etc. As is usual in SMTP protocol, SMTP server 145 will return an SMTP Status message 43 to the caller, in this case the E-mail formatter 142, which will in turn return an alert Written Status message 41 to alert router 141.

System log formatter 143 is responsible for writing messages to the system log. It is passed alert message data 42 by alert router 141. It formats a system log record 46, and writes it to system log file 146. After the write operation is complete, it will return an alert Written Status message 41 to alert router 141.

SNMP agent 144 is responsible for generating SNMP traps and forwarding them to SNMP manager 161. SNMP manager 161 is a commercial product as described above, such as CA-Unicenter from computer Associates Corporation, or HP/Openview from Hewlett Packard Corporation. SNMP agent 144 is passed alert message data 42 by the alert router 141. It formats an SNMP PDU 62 and sends it to SNMP manager 161, which will return an SNMP response 63. SNMP agent 144 then returns an alert written status message 41 to alert router 141.

The exact configuration of the various components of my firewall is relatively unimportant. For example, profile database 130 might not reside on firewall machine 280 as depicted in the preferred embodiment. It might reside on a separate machine that is not shown in any figures, or else it might reside on target manager computer 220. In another embodiment that protects database managers, the profile data may be part of the same database as comprises target database server 124. In another implementation, all of the various components might co-exist on a computer that is distinct from target server 120 databases being protected. In yet another implementation, the components might co-exist on the same computer platform on which target server 120 database executes. In yet another implementation, the various components could execute on a plethora of different computer platforms.

In operation a system, such as depicted in FIG. 3 through FIG. 9, is run under controlled conditions and normal operation can be established. When this system is run under conditions that might place it under attack, any deviations from behavior that was observed during normal conditions should be considered as possible attacks.

The system creates and stores such observations, when run under controlled conditions as described above. The system determines if subsequent observations have been stored when the system was run under controlled conditions; and to avoid falsely construing a behavior as an attack, the normal operation under controlled conditions should generate all possible such observations.

Action subsystem 110 of the firewall, as shown in FIG. 11 and FIG. 12 operates in two modes. In an alarm mode it behaves as previously described and detects out-of-pattern commands, and prevents adverse consequences of malicious attacks. In protecting database managers, action subsystem 110 detects out-of-pattern database queries and prevents malicious data loss from the database and preserves data privacy. This is shown in more detail in FIG. 12, which shows action subsystem 110, and in FIG. 16, which shows alert interface 140. In a learning mode action subsystem 110 monitors the behavior of client 100. When it is in learning mode, the firewall will monitor commands and check to see if an individual command has been previously encountered by the system. If it has not been encountered, then the system will add information about this particular query to its profile database.

Turning to FIG. 15, administration subsystem 150 provides interfaces that allow the administrator to perform a variety of tasks to control operation of the system and allow the administrator to monitor the operation the system. Administration subsystem 150 also allows the administrator to define how the system will behave if it does detect queries that are symptomatic of attack by malicious hackers.

To perform administration functions the system administrator responsible for its operation will use one or more of command line shell 155A, remote command line shell 155, web browser 158, or SNMP manager 161.

Typical functions of administrative interface 150 include the ability to:

a) Start the system,

b) Stop the system,

c) View all queries that are stored in the profile database 130,

d) Update a query that is stored in the profile database 130,

e) Delete a query from the profile database 130,

f) Add a new query manually to the profile database 130 (whether a valid query, or an explicitly invalid query),

g) Define actions to be taken in case an attack is detected (suppress the query, allow the query to proceed, return false data to the query, etc.),

h) Define alerting actions to be taken in case an attack is detected (defining the channels over which alerts should be sent and the exact destination to which they should be sent),

i) Switch the system into learning mode, where it records incoming queries in the profile database 130,

j) Switch the system into armed mode, where it scans incoming queries and generates alerts if an out-of-pattern query is detected, and

k) View the log entries associated with the system.

When graphical user interface 152 operates, it sends web browser 158A a series of screens which allow a system administrator to view and update configuration and log information that is stored within profile database 130, and to control the operation of the system (i.e. to start and stop the system). A web-based interface is utilized as a graphical user interface. However, the graphical user interface can be provided as a platform-specific windowed application, such as a Win/32 application on the Microsoft Windows platform, from Microsoft Corporation of Redmond, Wash.; or as a networked windowed application, such as X-Windows; or as a thick client application, with a client-side component on the system administrators desktop PC and a manager-side component on the manager; or as an Intranet thin-client application, with a client-side browser and a web-manager and application which updates the database.

If the system administrator chooses to use graphical user interface 152, the administrator will generally use a commercially available web browser 158A, such as Internet Explorer, by Microsoft Corporation of Redmond, Wash., or Netscape Communicator, by Netscape Corporation of Mountain View, Calif. Web browser 158A is directed by the system administrator to a URL which is responded to by the web server 159. As is usual in an HTTP-based system, the web browser 158A will send an HTTP request 58 to the web server 159, and the web server 159 will return an HTML Page 59 back to the web browser 158. By negotiating a series of menus, and HTML pages which display system data in HTML forms, the system administrator will be able to control the system.

Web server 159 invokes the actual system logic of administrative interface 150 via one or more Java-based Java application servlets 160. Other design options exist, such as CGI, or ISAPI or NSAPI. All of these other design options present difficulties: CGI tends to be difficult to secure and offers poor performance, ISAPI and NSAPI are more secure and better performing, but are specific to particular web managers. For this reason, a Java-based implementation is recommended, but other options are available and can be made to work satisfactorily.

As is the case in a Java servlet based implementation, one or more servlets (usually multiple) will implement the main logic of parsing and editing input parameters, communicating with other system components and building and formatting output HTML pages. The system is built as a series of individual and unique URLs which are mapped (within the Java servlet engine configuration data) to specific servlets. Thus, although Java application servlet 160 is referred to in the singular, it should be understood as being a collection of Java servlets. Graphical user interface 152 may be a single Java servlet or each specific function can be implemented as a discrete servlet.

A particular Java application servlet 160 is responsible for taking and validating input data passed to it by web server 159 from web browser 158 in an HTTP request 58. The HTTP request 58 is implemented as an HTTP POST. If the input is not valid, application servlet 160 will format an HTML page 59 indicating the error and return it to web server 159. In turn, web server 159 will pass the HTML page 59 back to web browser 158. If the request is valid, Java application servlet 160 will format a profile access request 56 and send it to interface Independent database access library 154. This component packages common logic within administrative interface 150 that is shared by the various interfaces: command line interface 151, graphical user interface 152, and SNMP interface 153.

Interface Independent database access library 154 formats the appropriate admin query 50 (in some cases more than one will be required to perform the specific function needed) and passes it to profile database 130. An admin result set 51 will be returned. If only one query was needed to satisfy a particular request, interface Independent database access library 154 will return a profile access response 57 to Java application servlet 160. If more than one admin query 50 is needed, interface Independent database access library 154 will perform each of them in turn until it is complete, and then it will return the profile access response 57 back to Java application servlet 160.

At this point, specific Java application servlet 160 will take the data contained within the profile access response 57, format the appropriate HTML Page 59 and return it to web server 159, which will in turn return it to web browser 158A.

Command line interface 151 is a conventional text-based command line interface. It accepts one or more commands which are entered by the system administrator at a command window specific to the particular computer platform. One such window, command line shell 155A, resides on the firewall machine 280 as shown in FIGS. 9 and 10. Another such window, remote command line shell 155, resides on a different machine for remote administration such as administration machine 250 also as shown in FIGS. 9 and 10. Such an interface may be: a .EXE file within the MS-DOS environment, from Microsoft Corporation of Redmond, Wash.; or an executable program accepting standard-in input within the Unix or Linux operating systems; or a shell script within one of the popular shell environments (such as Bourne, or Korn) within the Unix or Linux operating systems. Terminal emulation, such as VT100 may also be used. An actual text-based console may be used for command line shell 155A, in which case it would operate over an RS232C serial port connection to the firewall machine 280. The telnet protocol could also be used for remote command line shell 155.

Turning back to FIG. 10, each particular administrative function (starting the system, stopping the system, specifying operational parameters, etc.) is implemented as an individual command. Command line interface 151 may be a single command, with multiple subcommands, or an interactive command, such as FTP.

Thus the system administrator would type the name of the command which corresponds to a particular function within the system, as well as whatever flags and switches might be required for that particular command, using either command line shell 155A or remote command line shell 155. The selected shell 155A or 155 will find the correct library containing the executable code for the appropriate command, load it, pass the parameter strings to it and then transfer control to it.

Each command, although implemented independently, includes two parts. A command line parser 156 is required for those commands which accept sub-parameters. Command line parser 156 breaks down the parameter strings typed by the system administrator, and determines whether they are valid or not. If they are invalid, command line parser 156 for that command formats an appropriate error message as textual output 53 and returns it to shell 155A or 155 which will display it to the system administrator.

If the parameters of the command are valid, then command line parser 156 will format a command request 54 to command library 157. Command library 157 consists mainly of logic that is responsible for invoking interface Independent database access library 154, by formatting a correct profile access request 56.

Interface Independent database access library 154 will format the appropriate admin query 50 (in some cases more than one will be required to perform the specific function needed) and pass it to profile database 130. An admin result set 51 will be returned. If only one query was needed to satisfy a particular request, interface Independent database access library 154 will return a profile access response 57 to command library 157. If more than one admin query 50 is needed, interface Independent database access library 154 will perform each of them in turn until it is complete, and then it will return profile access response 57 back to command library 157.

Command line parser 156 will take profile access response 57 and reformat it as appropriate into textual output 53. This textual Output 53 will be returned to the command line shell 155 which in turn will display it to the system administrator.

Command line interface 151 and graphical user interface 152 are generally intended for use by human systems administrators in a manual way. However, in many cases, the system will be operated by enterprise systems automation software. Often such software will be SNMP-compliant and the system provides support for an SNMP interface, as well as for the previously described interface types.

As is usual in SNMP, SNMP manager 161 will send an SNMP PDU 62 to SNMP PDU handler 162. SNMP PDU handler 162 will parse the ASN.1 content of PDU 62 and determine whether it contains a valid request. If it is invalid, an SNMP response 63 will be returned to SNMP manager 161.

If the request is valid, SNMP PDU handler 162 will format a SNMP command request 64 and send it to SNMP command library 163. SNMP command library 163 is quite similar to command library 157 that supports command line interface 151.

SNMP command library 163 will, like the other previously described interfaces, format a profile access request 56 and send it to interface Independent database access library 154.

As previously described, interface Independent database access library 154 will format the appropriate admin query 50 (in some cases more than one will be required to perform the specific function needed) and pass it to profile database 130. An admin result set 51 will be returned. If only one query was needed to satisfy a particular request, interface Independent database access library 154 will return a profile access response 57 to SNMP command library 163. If more than one admin query 50 is needed, interface Independent database access library 154 will perform each of them in turn until it is complete, and then it will return profile access response 57 back to SNMP command library 163.

SNMP command library 163 will take profile access response 57 and, in turn, format the appropriate SNMP command result 65, and pass it back to SNMP PDU handler 162. SNMP PDU handler 162 will then format a SNMP response 63 and send it to SNMP manager 161.

As shown in FIG. 11, there is no direct connection between any of the subcomponents of administrative interface 150 and action subsystem 110. Therefore, in order for action subsystem 110 to pick up the most recent updates to the system parameters contained in profile database 130, action subsystem 110 will need to periodically poll profile database 130 to see if any parameters have recently been amended by a system administrator. Firewall system 282 may be made more responsive to system administrator changes by an inter-process communications (IPC) link between administrative interface 150 and action subsystem 110. Details of such IPC are highly operating system and language dependent and are not described here. Profile database 130 may alternatively be encapsulated with a persistence interface that is invoked by all components of firewall system 282 that require access to data. Both action subsystem 110 and administration subsystem 150 invoke this interface whenever there is a state change or event, and profile database 130 does not need to be directly invoked by either subsystem. A persistence interface can also accommodate the communications link referenced above.

When firewall system 282 shown in FIG. 11 is in a learning mode, action subsystem 110 will behave differently than when it is in armed mode. Details of action subsystem 110 are shown in FIGS. 12 and 13. Command manager 111 will receive an incoming command 10 from client 100 by way of communications manager 117, and will pass it as an Intermediate command 11 to command tokenizer 112. In most implementations, incoming command 10 and command query 11 will be identical in form, although it is possible that some practitioners in the art may find advantages to formatting them differently. Command tokenizer 112 will perform lexical analysis on incoming command 10 to break it down into symbols that represent the various tokens in that particular command language which is a database access language. More specifically, the database access language is SQL. However, other access languages may be used. For SQL, common symbols are commands such as “SELECT”, “JOIN”, “UNION”, etc. By processing Intermediate command 11 and tokenizing it, further analysis of the query is easily performed in subsequent steps. As lexical analysis has been well understood by practitioners of the art since at least the 1960's, it is not described in detail in order to not obscure the details of the invention. Output from command tokenizer 112, a tokenized command 12, will be passed directly to command parser 113. Command parser 113 will further process tokenized command 12 to ensure identification of which parts of the command are symbols and which are formal parameters of the command. The output from command parser 113, a Parsed command 13, will be passed to command analyzer 114.

When the system is in learning mode, command analyzer 114 will try to retrieve the command from profile database 130, which will entail retrieving, those decomposed elements of the command which uniquely characterize it. To accomplish this, command analyzer 114 generates a profile query 30 specifying the precise parameters that characterize the original incoming command 10, and pass it to profile database 130.

Additional information will also be assembled into the command that is processed within command analyzer 114. For example, in processing SQL queries, the user ID of the request is not embodied explicitly as a parameter in the database command 10B. Rather, it is established within the context of the connection that is created by a previously issued command. Therefore, command analyzer 114 must store the user ID of open connections in profile database 130 at the time that the “connect” commands are received, and then retrieve the previously stored value for the user ID to be added to each command that is sent to the profile in a profile query 30. In correspondence with this, the tables of profile database 130 also include fields for implicitly handled parameters such as user ID in addition to the explicitly passed parameters that are actually found in the processed SQL commands. Implicit parameters may arise in arbitrary circumstances whenever persistent connections, sessions, or contexts are employed. Although user ID is the most common such implicit parameter, others are possible.

If the command is found in profile database 130, a non-null profile result set 31 will be returned. Command analyzer 114 passes this information to action engine 115 in the form of command analysis 14. Action engine 115 will then pass a directive to communications manager 117 to allow the original incoming command 10 to be passed directly to target server 120 in unmodified form as the filtered command 15. This directive, command request 16, will be a message understood by communications manager 117 to permit the original command to pass through unmodified. The entire command and parameters from the action engine 115 may alternatively be passed to communications manager 117, rather than simply passing a request to pass the command that would otherwise be stored in communications manager 117 until it receives command request 16.

Next in the processing sequence, target server 120 will return a result 20 back to communications manager 117. The actual results passed back will vary, and depend on the original command and the state of target server 120. The result will be returned to the original client 100, as a result 20A. While the system is in learning mode, result 20 and result 20A will always be identical.

Under a different circumstance, if the query is not found in profile database 130, then command analyzer 114 will insert the decomposed elements that uniquely characterize the command into profile database 130. It will accomplish this by formatting an appropriate profile query 30, which in most implementations would be an SQL INSERT command, and waiting for profile database 130 to indicate that this has occurred successfully via a profile result set 31.

Where firewall protects a database manager, and where the environment consists of a two-tier web architecture as in FIG. 7 or a three-tier architecture as in FIG. 8, the system administrator will typically start the system, switch it into learning mode, and then operate the user computer running a web browser 230A in such a way as to execute various functions within the web application system running on web server computer 200A and application server computer 200B. The system administrator will try to ensure that the system receives all of the different queries that the web application system can generate. The administrator may choose to automate this process with a scriptable web browser or other custom tool that emulates typical user behavior using the browser to interact with the web application system. Additionally, the system administrator can use administrative interface 150 shown in FIGS. 11 and 15 to manually enter queries that are only infrequently generated by the application system. Additionally, the administrator may also add queries that may never validly be generated by the application (e.g. “SELECT * FROM CUST_TBL”).

Optionally, advanced versions of the system in accordance with the invention may also learn the sequence of queries that an application system will generate. For example, if a particular system always generates query A first, followed by query B, and by query C, then if query C is later suddenly seen without being first preceded by query A and query B there is a strong likelihood that a possible attack is in progress or that the application system is seriously malfunctioning.

Once the system administrator believes that all application functions have been exercised, and all possible commands captured in profile database 130, then the system administrator will switch the system into armed mode.

When the system is operating in armed mode, much of its behavior will be quite similar to when it is in learning mode. Specifically, action subsystem 110 receives an incoming command 10 from a client 100, and passes it, as an Intermediate command 11, to command tokenizer 112 as shown in FIG. 12. Command tokenizer 112 performs lexical analysis on Intermediate command 11 to break it down into symbols that represent the various tokens in of the command language to which the command belongs. Output from the command tokenizer 112 is passed directly to command parser 113, as a tokenized command 12. Command parser 113 will further process the command to ensure that the system is able to appropriately decide which parts of the command are symbols and which are formal parameters of the command. The output from command parser 113 is passed to the command analyzer 114, as a Parsed command 13.

When the system is in armed mode, command analyzer 114 will try to retrieve the command or, more precisely, the decomposed elements of the command which uniquely characterize it, from profile database 130. It will accomplish this by formatting a profile query 30, and passing it to profile database 130.

If the command is found in profile database 130, a non-null profile result set 31 will be returned, signifying that that the particular incoming command 10 is one that has been legitimately generated by the correct application. Command analyzer 114 passes this information to action engine 115 in the form of the command analysis 14. Command analysis 14 contains the data that was retrieved about the query from profile database 130, including policy level information about what actions should be taken. Action engine 115 will then pass a directive to communications manager 117 to allow the original incoming command 10 to be passed directly to target server 120 in unmodified form as the filtered command 115. This directive, command request 16, is a message understood by communications manager 117 to permit the original command to pass through unmodified. In an alternative embodiment the entire command and parameters are passed from action engine 115 to communications manager 117, rather than simply passing a request to pass the command that would otherwise be stored in communications manager 117 until it receives command request 16.

Next in the processing sequence, target server 120 returns a result 20 back to communications manager 117. The actual results passed back will vary, and depend on the original command and the state of target server 120. The result will be returned to original client 100, as a result 20A. Note that, in this case, where incoming command 10 was found to be legitimate, result 20 and result 20A are always identical.

If the command is not found in profile database 130, then command analyzer 114 will retrieve the appropriate policy records from profile database 130 and format that information, along with the information about the command that was not found, as command analysis 14, and pass it to action engine 115. Action engine 115 will decide whether to:

a) Allow the command to execute by passing it unchanged to target server 120, or

b) Return a null result 20A with command status codes which indicate that the command is invalid, or

c) Return a previously stored set of false data as result 20A.

Where the firewall protects a database manager, the three possible outcomes are analogous:

a) Allow the query to execute by passing it unchanged to the target database server 124, or

b) Return a null result set 20B with command status codes which indicate that the command is invalid, or

c) Return a previously stored set of false data as result set 20B.

Results would likely be intended to deceive the attacker into believing that actual data was returned, or else that an error has occurred. It is also possible that the results would reflect the fact that an attack has been detected. One skilled in the art will appreciate that well-engineered security systems give potential attackers as little information as possible about the detection of an attack, so as to not further aid the attack process.

The process described above wherein command analyzer 114 generates a command analysis 14 is referred to as the “analysis step”. This step is the sequence of activities during processing in which a command 10 may be deemed characteristic of a normal application program.

The process of communications manager 117 preventing incoming command 10 from reaching target server 120 is designated as the “preventor step” and is an important step in the processing sequence of the invention. Because of the preventor step, incoming commands 10 never reach target server 120 unless specifically made to do so by the action of communications manager 117 after the analysis step.

The process of communications manager 117 forwarding incoming command 10 to target server 120 is designated the “forwarding step”.

As is shown in FIG. 16, action engine 115 will then pass details about the offending command, along with the appropriate policy records from profile database 130, as command and attack data 40 to alert subsystem 140. Alert subsystem 140 is responsible for formatting and processing alerts in the various output formats which may be desired by systems or security administrators. The following description covers the major formats and interfaces which are desirable, but there are a number of other formats and interfaces, such as dialing out to a paging system, which could reasonably be supported by the system that would be implemented in a similar fashion. In the exemplary embodiment, alert subsystem 140 will determine whether the alert should be sent in an SMTP e-mail, written to the log file, or forwarded as an SNMP trap. Other e-mail formats could be used, but SMTP is an extremely widely used standard and is likely to predominate. SMTP is a widely recognized standard and thus the details of formatting SMTP records will not be described further.

Alert router 141 is the major management component of alert subsystem 140. It receives all command and attack data 40 and is responsible for deciding what actions to take based on that data.

If the policy information passed in command and attack data 40 indicates that an e-mail is required, then alert router 141 will call e-mail formatter 142 to format the necessary SMTP records. It will do this by sending an alert message data 42 that contains all the information about the attack in question, as well as the destination e-mail address. Once email formatter 142 has formatted the necessary e-mail records, they will be forwarded to an SMTP server 145 for delivery, by sending a series of SMTP messages 44. SMTP server 145 is a commercial or open source implementation of an SMTP manager, such as Q/Mail or SendMail. As is usual in SMTP protocol, the SMTP server 145 will respond with an SMTP Status message 43 per SMTP message 44 that is sent to it. Once all such messages associated with sending the e-mail have been processed, e-mail formatter 142 will return an alert Written Status message 41 to alert router 141, indicating whether or not the e-mail was processed properly.

If the policy records indicate that the event should be recorded in system log file 146, alert router 141 will call the log formatter 143, by sending it alert message data 42. Log formatter 143 will format the data into an appropriate format, depending on the specifics of the operating system on which it is executing. Log formatter 44 will then write the appropriate record(s) to system log file 146, as a system log record 46. Once log formatter 143 has finished processing, it will return an alert written status message 41 to alert router 141, indicating whether or not the writing of the log messages was processed properly.

If the policy records indicate that the event should be forwarded as an SNMP trap alert, then alert router 141 will call the SNMP agent 144 to format the necessary SNMP trap alert, by sending it alert message data 42. SNMP is a widely recognized standard, and thus the details of formatting SNMP traps are not described. Once the SNMP trap has been formatted by the SNMP agent 144 it will forward the alert to the appropriate SNMP manager 161 by sending it a SNMP PDU 62, and will receive back an SNMP response 63. SNMP manager 161 is a commercial or open source implementation of an SNMP service: CA-Unicenter, from Computer Associates Corporation of Islandia, N.Y., or HP/Openview, from Hewlett Packard Corporation of Palo Alto, Calif. Once SNMP agent 144 has fully processed the alert it will return an alert Written Status message 41 back to alert router 141, indicating whether the SNMP trap was processed properly.

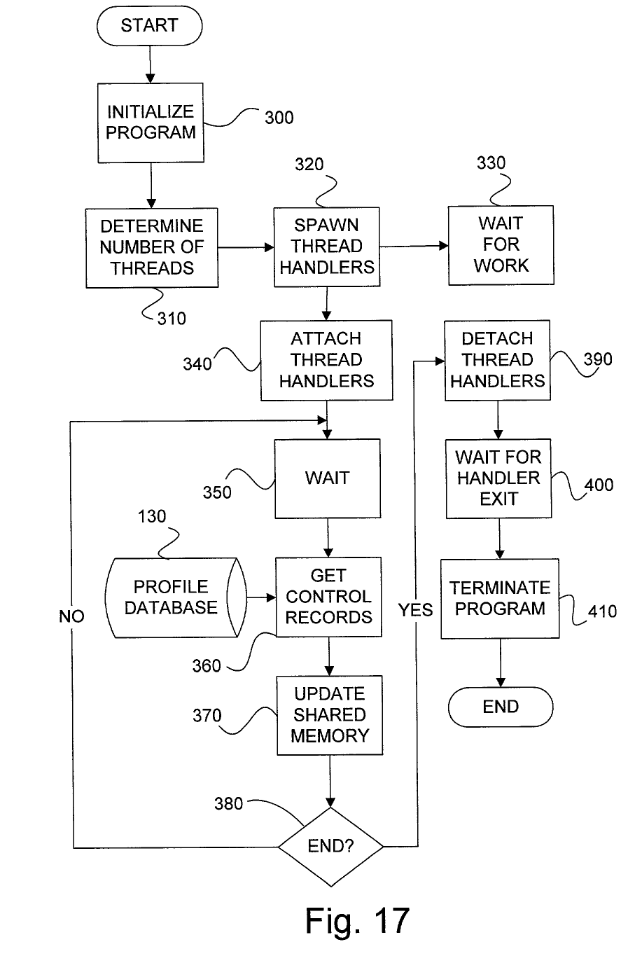

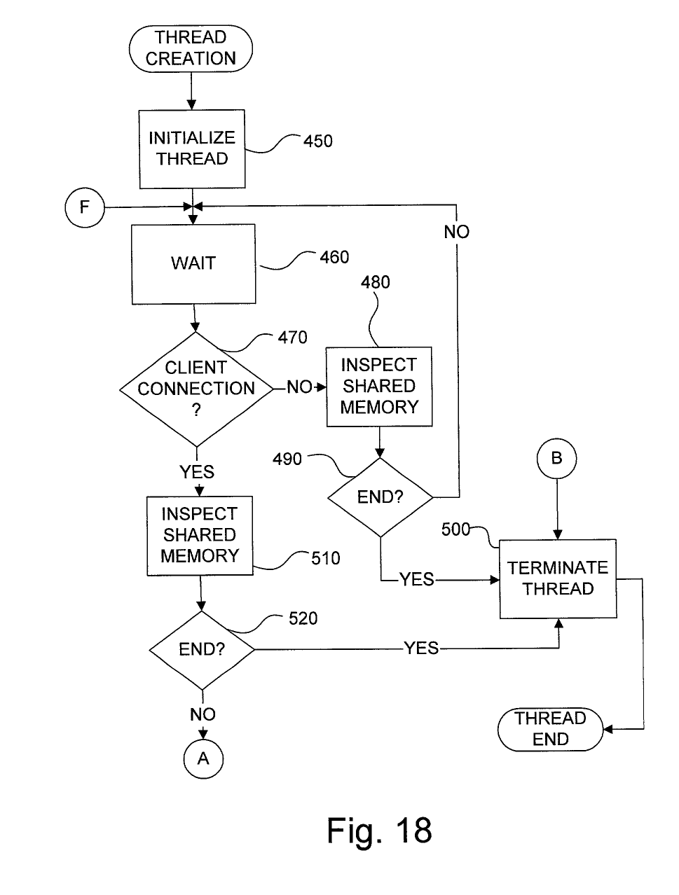

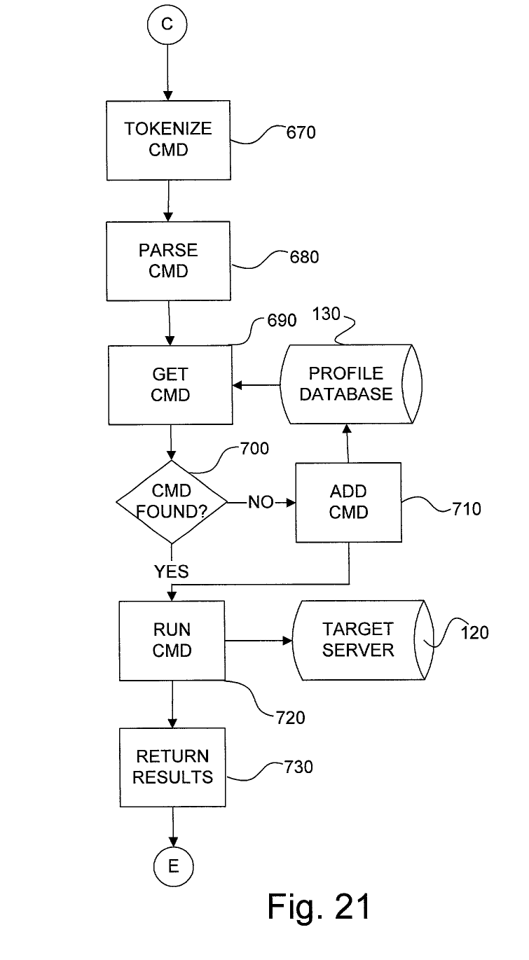

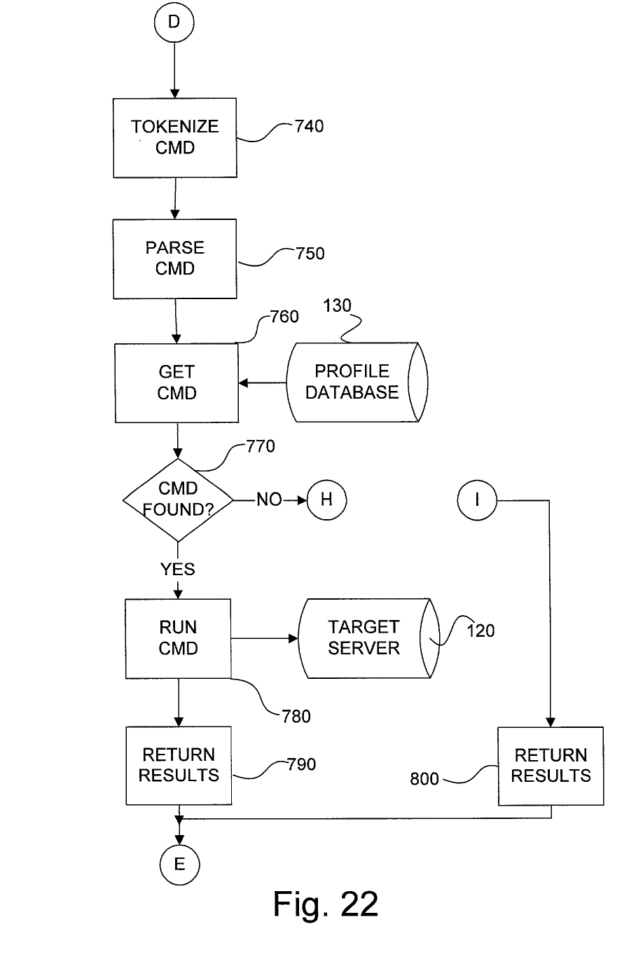

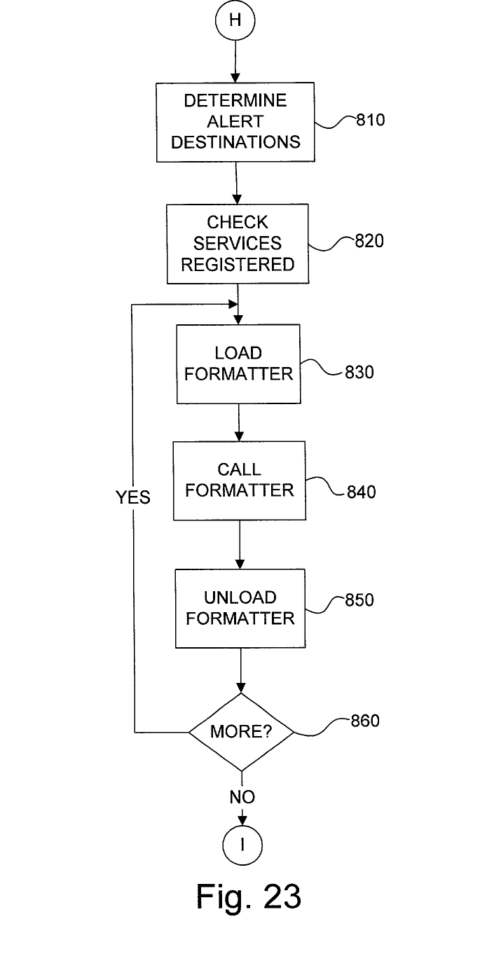

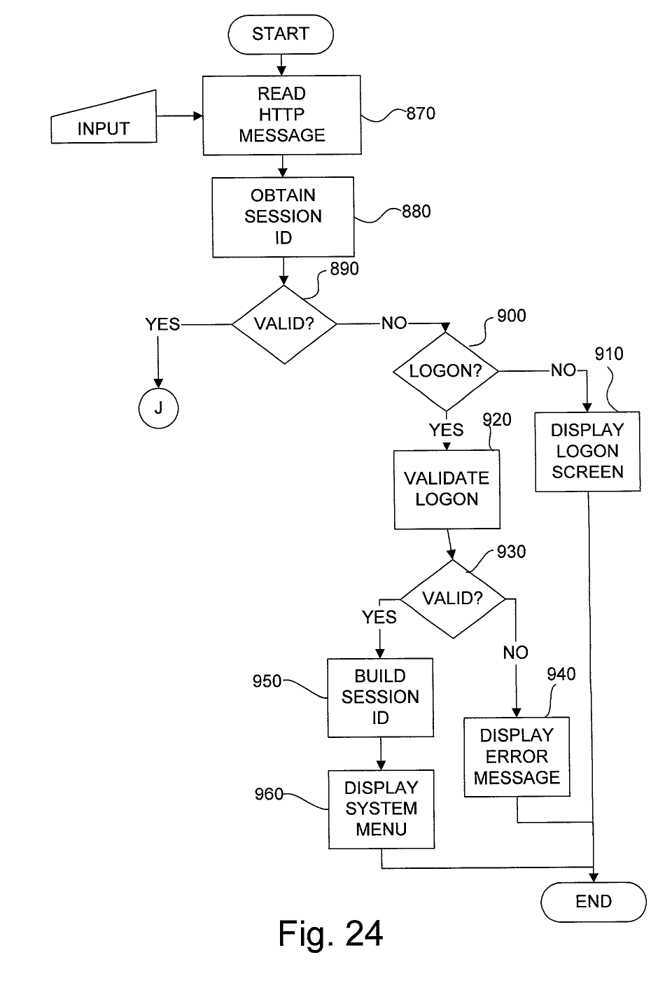

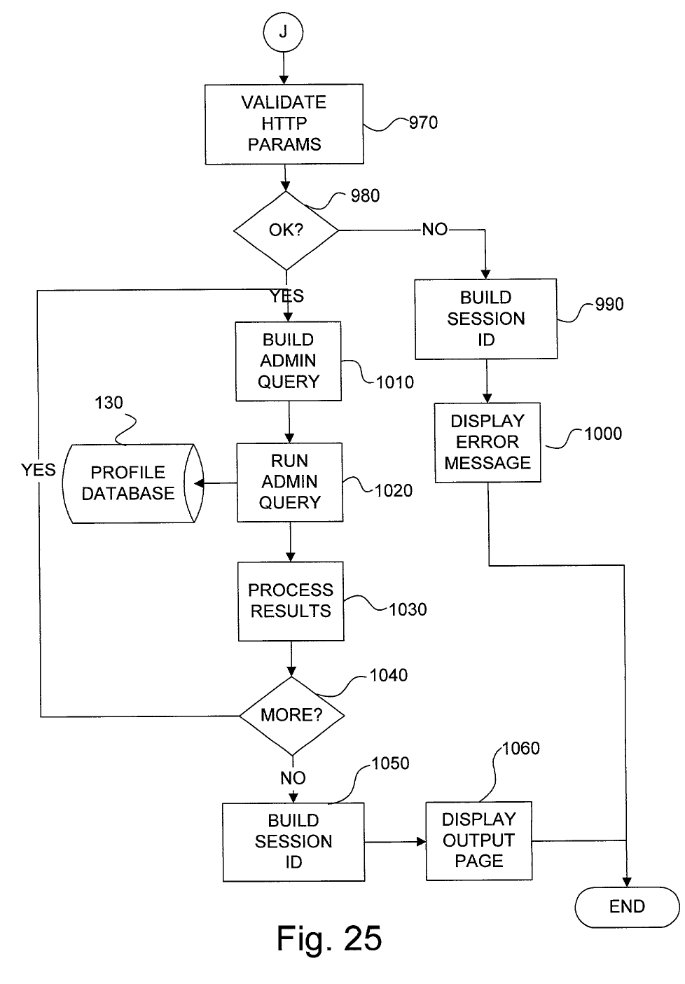

The behavior described above is shown in more detail in the flowcharts in FIGS. 17 through 25. FIG. 17 is a flowchart which describes the high level operation of initializing and terminating the system. FIGS. 18, 19 and 20 are flowcharts that describe the common thread-based operation of action subsystem 110, and the administration subsystem 150. FIG. 21 is a flowchart showing the behavior of action subsystem 110, when it is in learning mode, and FIG. 22 shows its operation while in Alarm mode. FIG. 23 is a flowchart that describes the operation of the alert subsystem 140. FIGS. 24 and 25 are flowcharts that describe the operation of administration subsystem 150.

As one skilled in the art will readily appreciate, error-handling logic often comprises in excess of 50% of the code in a program. As it does not help to explain the firewall of the invention, this logic has been omitted for clarity in the descriptions contained herein.

FIG. 17 shows high-level operation of starting and stopping the system. All practical managers such as database management systems (DBMSs) are multi-threaded and can accept, and process, multiple connections simultaneously. The preferred embodiment of the system of the invention acts as a DBMS firewall and is capable of simultaneously supporting multiple connections through it to target database server 124. This causes certain complications that are addressed in more detail here. First, the system is multi-threaded. As thread management is highly operating system and programming language dependent, it is not described in detail, in order to not obscure the details of the invention. Second, a relatively simple method of inter-process communication (IPC) is provided by the use of shared memory 170. Other IPC mechanisms, such as semaphores, etc., are arguably more robust, but harder to explain as they are highly operating system and programming language dependent.

The logic of FIG. 17 moves from the start to block 300, wherein the program is initialized. As is usual, this involves initializing of various program variables and registers, establishing a connection pool to be used to access profile database 130, registering various alerting formatters, starting other services (such as the web manager used by the administrative interface 150) and so forth. The logic then moves to block 310, where the number of threads supported by the target server 120 is determined. This is accomplished in a number of different ways. For some types of database servers 124, a program interrogates database server 124 and directly obtains the permissible number of connections; in other cases, the configuration information that database server 124 uses is read to determine the connection limit; or the data is hard coded within the configuration information used by the firewall. The logic then moves to block 320 where the main parent process spawns a number of dependent threads, one per manager connection, up to the maximum determined previously in block 310. In block 330, each dependent thread will start execution, and move into a state of waiting for work. The logic of these dependent worker threads is described in considerably more detail in FIGS. 18 through 20, FIG. 21 and FIG. 23, and implements the logic of action subsystem 110 and alert subsystem 140.

Meanwhile, after the parent thread has finished spawning dependent worker threads, it will then move to block 340 and attach the worker threads to the manager connections. These connections are database connections, although one skilled in the art will appreciate that different embodiments will handle connections in a variety of ways that may necessitate other types of thread handling. For example, stateless connections that do not persist from one command to the next utilize thread pooling instead of attempting to assign a single handler thread per stateful connection as is described here. The firewall of the invention is placed between client 100 target server 120 and both acquires all connections available from the target database server 124 and present the same number of connections to potential clients 100 which are using the native database client library 104A. This occurs in block 340, where inbound and outbound connections are matched to the worker threads that were previously spawned.

Once all this logic has been completed, the main processing occurs in the worker threads, and will be described later in considerably more detail. However, the parent thread is still active and is still responsible for one task—ensuring that the worker threads are coordinated when changes to system parameters occur, such as switching from learning mode to alarm mode, and for performing an orderly termination of the system. As described above, periodic polling to profile database 130 is used as the mechanism to accomplish this. Therefore, when the logic reaches block 350, the main thread waits for a predetermined period of time and then resumes execution. The period of time waited is set by default when the program initialized, and is updated thereafter by a value retrieved from the profile database 130. The time interval would typically be on the order of 10 to 30 seconds, although other values could certainly be used.

When execution resumes, it will do so in block 360, where the main thread retrieves the most current system status information from the profile database 130. The logic then moves to block 370 where shared memory 170 values that can be inspected by the various worker threads, are updated with appropriate values from profile database 130.

One of the values retrieved from profile database 130 will indicate whether the system should terminate. This value is inspected in test 380. If the system is to continue execution, the main thread will return to block 350 and wait again.

If the system is to terminate, the logic moves to block 390, where all worker threads are detached from target server 120 database and will no longer accept new work. Programmatically, this is complex to achieve because the program also has to deal with the case where some of the worker threads are actively processing requests on behalf of a client 100. Generally, worker threads detect that a termination has been requested (by periodically inspecting the appropriate value in shared memory 170) and should terminate themselves, if they are not processing work for a client 100, or finishing up the last request on behalf of a client 100, if they are, and then terminating.

Once the main thread has requested that all worker threads terminate, it then waits in block 400 for that to occur. As an active worker thread finishes processing a particular request, it will finally terminate. When they have all terminated, the main thread will resume processing. Depending on the operating system and programming language facilities available, this is performed directly using sophisticated inter-process communication facilities, or by the main thread simply inspecting appropriate shared memory 170 values to determine the status of the dependent worker threads, waiting for a period of time, and so on.

Once all dependent worker threads have stopped processing client 100 requests, cleaned up and terminated execution, the main thread will resumes execution at logic block 410. Here, it cleans up all residual program resources, such as closing its connection pool to the profile database 130, releasing memory, especially shared memory 170. When cleanup is complete execution is terminated and ended.

In FIG. 18, the logic starts execution—this corresponds to creation of a particular worker thread by the parent thread. In this case, the logic described corresponds to the processing performed by the system while it is in learning mode. After execution starts, the logic moves to block 450, where the thread initializes any thread specific storage, etc. The logic then moves to block 460, where this thread waits. In block 460, the event that the thread is waiting on is for a manager connection request to be sent from a client 100. If this does not occur within a few seconds, then the wait will end.

The logic then moves to test 470, where the thread determines if a manager connection request has occurred. If a request has not been received, the logic moves to block 480, where the thread examines shared memory 170 to see if the parent thread has requested that this dependent thread should terminate. In test 490, the thread determines whether such a termination request has been made. If the thread is not to terminate, then the logic returns to block 460, and waits again. FIG. 18 characterizes the flow for the specific preferred embodiment that involves database connections.

If a termination request has been made, then the logic moves to block 500, where the thread cleans up prior to exit. Because, as will soon be explained, block 500 may be entered by the thread when it is in the state of processing various requests on behalf of a client 100, this logic will need to take account of this and clean up these conditions differently. For example, if a connection request has been received from a client 100, but no command has yet been received, then the clean up process needs to close the connection back to the client 100, whereas in other circumstances it would not need to do so. Once all relevant thread specific cleanup has occurred, the thread exits.

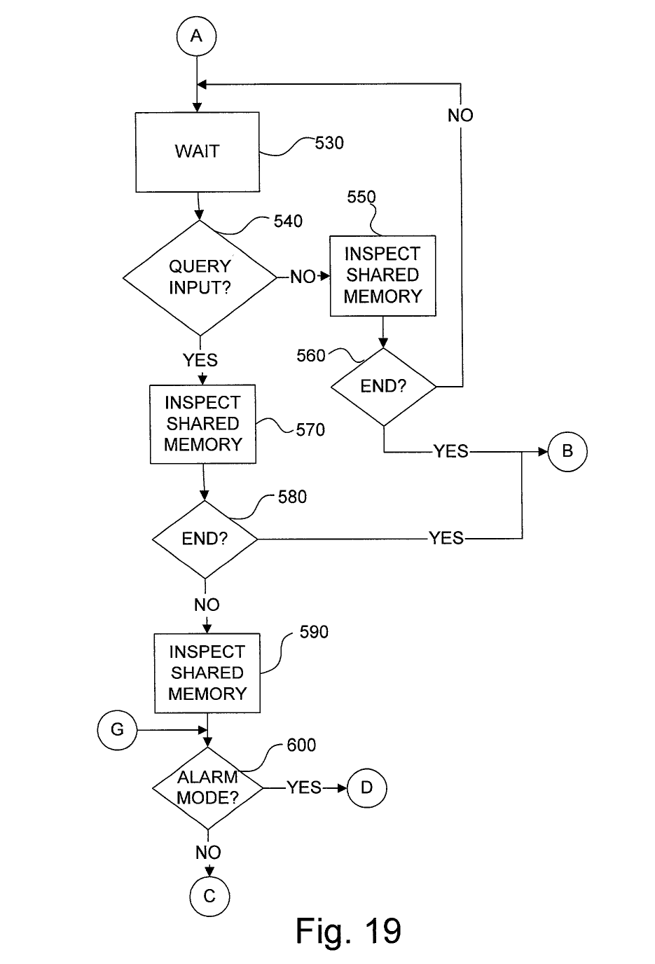

From test 470, if a client connection request was received, the program moves to block 510 where shared memory 170 is again inspected. The logic then moves to test 520 where the thread determines if it should exit or not. If the parent thread has requested that it should exit, then the logic moves to block 500, as described above. If processing should continue, then the logic moves, via connector A, to FIG. 19 where it starts at block 530.

In block 530, the thread again performs a conditional wait. This time, it waits for a command to be received from client 100. The wait will either end when the wait time has expired, or a command is received from client 100. The logic moves to test 540, to determine which of these two cases has occurred. If no input command was received, the logic moves to block 550, where shared memory 170, again is inspected. In test 560, if the parent thread has not requested that the dependent worker thread should exit, then the logic returns to block 530 to wait again. Otherwise, if the parent thread has requested that the dependent worker thread should exit, then the logic returns to block 500 in FIG. 18, via connector B, to perform the termination logic, as described above.

In test 540, in FIG. 19, if an input command is received, then the logic moves to block 570, where shared memory 170 is again inspected. In test 580, the dependent worker thread determines if it has been requested to terminate, by the parent thread. If it has, then the logic returns to block 500 in FIG. 18, via connector B, to perform the termination logic, as described previously. If it has not, then the logic continues in block 590, in FIG. 19, where shared memory 170 is inspected again.

In test 600, the logic determines (by use of the appropriate shared memory 170 setting), whether the system is in Alarm mode, or learning mode. If it is in learning mode, then execution continues, via connector C, in block 530 in FIG. 21. If it is in Alarm mode, then execution continues, via connector D, in block 740 in FIG. 22.

The system of the invention includes memory wherein a database query or other database command from a database client may be saved in a permanent fashion. This occurs as follows. In FIG. 21, execution continues in block 670, where the dependent worker thread takes the Intermediate command 11 and tokenizes it through lexical analysis, wherein an input data stream is broken into syntactic tokens, based on the appropriate delimiters (white space, commas, parentheses, etc.) that are valid for that particular data access language.

The logic then moves to block 680, where the symbol table produced earlier is parsed within the constraints of the particular command language, which would be a database language, SQL. The parsing performed here is similar to the second stage of a language compilation. The tokens in the symbol table are mapped against the dictionary for the particular manager language, SQL, and each entry in the symbol table is assigned a type value which identifies what kind of language element it is.

Based on this analysis, the system now is able to distinguish the fixed structure of the command, from the variable parts within it. So, for example, in the specific preferred embodiment, if the same query (structurally) is used to retrieve the information about one customer (customer “A”) and then a second customer (customer “B”), the system ascertains that these two queries are in fact identical, and only the retrieval key differs.

The logic then moves to block 690, where the dependent worker thread takes the Parsed command 13, and builds the appropriate query to profile database 130, to see if this particular incoming command 10, has been processed by the system before. The system then sends the query just built to the profile database 130, for execution.

The logic then moves to test 700, where the dependent worker thread takes the status information returned from the query to the profile database 130 to determine if the particular incoming command 10 has been processed before. If it has not, then the logic moves to block 710, where the system adds the information about the command to the profile database 130.

Regardless of whether the command was, or was not, present previously in the profile database 130, it now is, and thus execution moves to block 720. Here, filtered command 15 is presented to target server 120, for execution. The logic next moves to block 730, wherein the results that are obtained from the target manager server 120 are returned to the client 100, as result 20A.

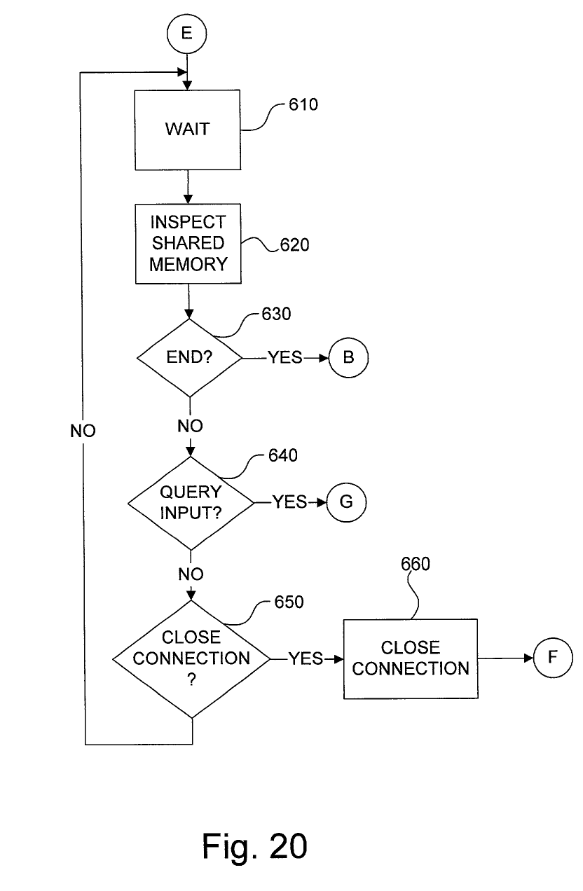

The logic moves, via connector E, to block 610 in FIG. 20. The dependent worker thread has now processed a single command and therefore it now waits for either a connection close request, or for another command to be sent to it by client 100. Thus, in block 610, the dependent worker thread performs another conditional wait upon a period of time, a connection close request, or another database query.

When the wait ends, the logic moves to block 620, and inspects the contents of shared memory 170. In test 630, the dependent worker thread determines whether it has been instructed to terminate by its parent thread. If it has, it returns to block 500, in FIG. 18 via connector B.

If it has not been instructed to terminate, the logic next moves on to test 640 in FIG. 20. Here, it determines whether client 100 has sent it another command to process. If it has been sent another command the logic returns to test 600 in FIG. 19 via connector G.

If it has not been sent another command, the logic moves on to test 650 in FIG. 20. Here, it determines whether client 100 has sent it a connection close request. If it has been sent such a request, the logic moves to block 660, and closes the connection on behalf of client 100. The logic moves to block 460 in FIG. 18 via connector F.

Analysis determines whether a command is characteristic of an attack. This occurs as follows. In FIG. 22, execution continues in block 740, where the dependent worker thread takes the Intermediate command 11 and tokenizes it through lexical analysis, wherein an input data stream is broken into syntactic tokens, based on the appropriate delimiters (white space, commas, parentheses, etc.) that are valid for that particular data access language.

The logic moves to block 750, where the symbol table produced earlier is parsed within the constraints of the particular command language which would be a database language, SQL. The parsing performed here is again similar to the second stage of a language compilation. The tokens in the symbol table are mapped against the dictionary for the particular manager language in consideration, such as SQL, and each entry in the symbol table is assigned a type value which identifies what kind of language element it is.

Based on this analysis, the system distinguishes the fixed structure of the command, from the variable parts within it. So, for example, if the same query (structurally) is used to retrieve the information about one customer (customer “A”) and then a second customer (customer “B”), the system will be able to ascertain that these two queries are in fact identical, and only the retrieval key differs.

The logic moves to block 760, where the dependent worker thread takes parsed command 13 and builds the appropriate query to profile database 130, to see if this particular incoming command 10 has been processed by the system before. The system sends this query to profile database 130 for execution.

The logic moves to test 770, where the dependent worker thread takes status information returned from the query to the profile database 130, to determine if the particular incoming command 10 has been processed before. If it has not, then the logic moves to block 810, in FIG. 23, via connector H. This invokes alert subsystem 140. Upon return from alert subsystem 140, execution returns to block 800. Here, the logic returns some kind of result 20A, to client 100, but as incoming command 10 was never presented to target server 120, the results are not the actual output from the command. Instead, the results sent back to client 100 are based upon parameters stored in profile database 130, and subsequently placed in shared memory 170. Then, the logic moves to block 610 in FIG. 20 via connector E.

In FIG. 22, the logic moves to block 780. In block 780, the filtered command 15, is passed to target server 120 for execution. Once execution of the command is complete, the logic moves to block 790 where the results from the command are passed back to client 100 as result 20A. The logic moves to block 610 in FIG. 20 via connector E.

When a previously unprocessed command is detected by the system and it is in alarm mode, the logic moves to block 810, in FIG. 23, via connector H. This pertains to alert subsystem 140. To recapitulate, alert subsystem 140 is sent command and attack data 40, which describes the details of the command that is being used to attack the system, as well as destination-specific information about where individual alerts should be sent.

In block 810, the system determines which alerting destinations and interfaces have been requested by action engine 115 via command and attack data 40.

The logic moves to block 820, where alert router 141 determines whether alert formatters for all of these destinations were registered to the system when it initialized, plus locate alert formatters needed for processing the current alert.

The logic moves to block 830, where it loads a formatter specified in command and attack data 40. The specifics of such loading are highly operating system and programming language dependent. However, loading a DLL within the Microsoft Windows Win32 environment is one example. Block 830 is invoked repeatedly, within an iterative loop, once per alerting interface. Therefore, the first time it is invoked, it loads the first alerting interface; the second time it is invoked, it loads the second alerting interface, and so on.

The logic moves to block 840, where it calls the alert formatter that was just loaded in block 830. A specific formatter takes the information supplied to it in the command and attack data 40, formats the information in a way that is suitable for that particular destination, and then sends it to the particular destination. In the case of an SMTP formatter, it takes command and attack data 40, formats a series of SMTP records, opens a connection to an SMTP manager, sends the records in sequence to the SMTP manager, and then closes the connection.

After the alert formatter has successfully completed, the logic moves to block 850, where it unloads the particular alert formatter just used.

After a particular alert formatter has been unloaded, the logic moves to test 860, where it determines whether there are any more alert destinations to be processed. If there are, the logic returns to block 830, to process the next one.

If there are no more formatters to be called, the logic returns, via connector I, to block 800 in FIG. 22.

In FIGS. 24 and 25, the logic associated with administration subsystem 150, is shown. In the prior description, I have discussed a command line interface 151, a graphical user interface 152, and an SNMP interface 1153. In the flowcharts depicted in FIGS. 24 and 25, I have only shown the flow for the graphical user interface 152. Implementations of a command line interface 151 are extremely operating system specific. Unless otherwise indicated in the following description, the logic described below is all contained within application servlet 160 layer and the interface independent database access library 154.

The logic of FIG. 24 moves from the start to block 870, wherein the program obtains the incoming HTTP request 58, as originally supplied via web browser 158A and web server 159.

The logic moves to block 880, where the system determines if the message contains a valid and un-expired session identifier. HTTP protocol is stateless and therefore the application programs themselves must manage a customer's session state. There are three generally accepted methods of storing a session identifier within HTTP protocol, so that it is always returned back to web server 159: a) using temporary cookies, b) URL re-writing, and c) hidden fields. Each of these has different advantages and disadvantages, but all work. In the embodiment of the invention cookies are used.

In block 880, the logic retrieves the cookie from the headers of the HTTP request 58, unpacks the session identifier from the cookie, and then performs a series of steps to determine whether the cookie is valid or not. The session identifier is such that it is quickly to generated and validated (in terms of execution overhead) and extremely resistant to forgery by an attacker.

The logic moves to test 890, where it determines whether the session id is valid or not. If it is, the logic moves to block 970, via connector J, in FIG. 25.

Continuing in FIG. 24, if the session was found not to be valid in test 980, then the logic moves to test 900, wherein the URL is inspected to determine if the user is attempting to log on. If the user is not attempting to log on, then the logic moves to block 910, where the logon page is formatted and sent to web browser 158A via web server 159.

If it was determined in test 900 that the user is attempting to log on, then the logic moves to block 920, where the logon information supplied by the user is validated. There are many different ways in which logon information may be validated such as the use of LDAP, NT Domain Security, Novell LAN logon, or other operating system authentication mechanism available on the platform.

Once logon has been validated, the logic moves to test 930, where it is determined whether the logon information is valid or not. If it was invalid, then the execution moves to block 940, where a suitable error message is built, and the logon screen resent to the web browser 158A via web server 159.

If the logon information is determined to be valid in test 930, then the logic moves to block 950 where a new session identifier is built. The logic moves to block 960, where the initial menu screen for the administrative interface 150 is built and sent to web browser 158 via web server 159.

In FIG. 25, execution continues in block 970, where the parameters (i.e., the field values from the input page) that have been set in the HTTP request 58 are validated. The logic moves to test 980, where if these parameters are invalid, the test will move to block 990, where a session id will be built. Then the logic will move to block 1000, where the appropriate error messages are built and then inserted into that particular page. The page is then output to web browser 158A via web server 159.

If the parameters are determined to be valid in test 980, then the logic moves to block 1010 where the appropriate admin query 50 is built for the function that the system administrator is performing. In most cases, this query is some kind of SQL query.

The logic moves to block 1020, where the admin query 50 that was constructed in block 1020 is sent to profile database 130, for execution. The logic moves to block 1030, where the admin result set 51 returned from the profile database 130 is examined and processed.

The logic moves to test 1040, where the program determines if that query was enough to satisfy the particular request (as would be the case for an insert function, for example), or if another query is needed (if it is an update function, for example). If another query is required, then the logic returns back to block 1010, where that next query is generated, and so on.

If that query was the last one needed, then the logic moves to block 1050, where a session identifier is built. The logic moves to block 1060, where the appropriate output page is built, using input parameters provided by the system administrator, and the various result set(s) obtained from profile database 130. This page is sent to web browser 158A via web server 159.

Other mechanisms for storing and retrieving persistent data will also work, such as files. Constant data may also be used in the code of the computer program that comprises the firewall for storage of static information. For example, parsed commands 13 can be stored in the computer program itself and not in a separate component at all. In this alternative embodiment, code generation and compilation would be provided after the learning mode has completed and before the alarm mode is invoked. Commands generated during learning mode would be stored to some sort of storage, for example, source code files that contain statically initialized string constants. Before deployment, these files would be compiled into libraries or executables that are then accessed by the system during operation. Instead of querying the profile database 130, the system would attempt to retrieve a parsed command 13 from the static code that has been compiled prior to deployment of the system in Alarm mode.

A system and software in accordance with the invention will effectively stop malicious hackers who have managed to compromise the managers that support an electronic commerce web site from being able to successfully download the contents of the core customer database. Moreover, the invention will stop hackers from accessing arbitrary managers, when those hackers have managed to compromise the machines that contain clients to those managers.

Although the invention has been described in terms of specific embodiments, it is not intended that the invention be limited thereto. As will be evident to those skilled in the art, various changes and modifications may be made to the embodiments without departing from the spirit or scope of the invention. One such example, is using different pattern matching algorithms to determine if a particular database access request has been seen before, by use of artificial intelligence techniques such as neural networks. It is intended that the invention include all such changes and modifications. It is intended that the invention be limited in scope only by the claims as appended hereto.

What is claimed is:

1. A method for intercepting a command sent to a manager program generated by a client program and determining whether said command is characteristic of a normal application program, the method comprising the steps of:
intercepting said command;
preventing the direct sending of said command from said client program to said manager program;
performing an analysis upon said command;
sending said command to said manager program if said analysis determines that said command is characteristic of a normal application program; and
preventing said command from reaching said manager program if said analysis determines that said command is not characteristic of a normal application program;
whereby said manager program is protected from commands that are sent from a client program that is under control of an attacker.

2. The method of claim 1, further comprising the step of:
permanently storing said command.

3. The method of claim 1, further comprising:
alerting an administrator through a notification channel if said analysis determines that said command is not characteristic of a normal application program.

4. The method of claim 1, further comprising:
storing normal patterns that correspond to commands generated by said normal application programs;
said analyzing step comprises:
determining whether said command corresponds to any of said stored patterns, and
determining whether said command is characteristic of a normal application program if said analysis determines that said command corresponds to any of said stored patterns.

5. The method of claim 1, further comprising:
storing attacker patterns that correspond to commands generated by a client program that is under control of an attacker,
said analyzing step comprises:
determining whether said command corresponds to said stored attacker patterns, and
determining that said command is not characteristic of a normal application program if said analysis determines that said command corresponds to any of said attacker patterns.

6. The method of claim 1, wherein:
said manager program is a database manager.

7. The method of claim 6, wherein:
said command is a Structured Query Language query.

8. An application firewall program for intercepting a command sent from a client program to a manager program and determining whether said command is characteristic of a normal application program, comprising:
a preventor step to prevent the direct sending of said command from said client program to said manager program;
an analysis step whereby said command is analyzed to determine if it is characteristic of a normal application program; and
a forwarding step in which said command is sent to said manager program provided said analysis determines that said command is characteristic of a normal program; and
a prevention step in which commands that are not characteristic of a normal application program are prevented from reaching said manager program.

9. The application firewall program of claim 8 further comprising:
data storage.

10. An application firewall machine comprising:
a first network interface coupling said firewall machine to a client computer via a first network segment;
a second network interface coupling said firewall machine to a manager computer via a second network segment;
a communications manager coupled to said first and second network interfaces, said communications manager being operable to read and write data to said first and second network segments via the corresponding first and second network interfaces, said communications manager being further operable to not permit direct passage of network communications across the network interfaces, and operable to send data to said manager computer when analysis determines that data coming from said client computer contains a command that is characteristic of a normal program; and
a command processor to process said data to identify commands that are being passed as requests from said client computer to said manager computer, and
a command analyzer to analyze said commands to determine if said commands are characteristic of a normal application program.

11. An application firewall machine in accordance with claim 10 wherein:
said client machine comprises a database client program, said database client program being operable to generate commands that are directed to said manager machine; and
said manager machine comprises a database manager program, said database manager program receiving commands sent by said client machine.

12. An application firewall machine in accordance with claim 11 wherein:
said commands are SQL commands;
said client machine comprises a database client program generating said SQL commands directed to said manager machine; and
said manager machine comprises a database manager program capable of receiving said SQL commands.

13. An application firewall machine in accordance with claim 10 further comprising:
a data storage manager.

14. An application firewall machine in accordance with claim 13 wherein:
said storage manager comprise stored data representing invalid commands that said client computer should never generate and which are indicative of attack; and
said command analyzer utilizes said data representing invalid commands.

15. An application firewall machine in accordance with claim 13 wherein:
said storage manager comprise stored data which represents only normal commands that said client computer should generate; and
said command analyzer utilizes said stored data.

16. An application firewall machine in accordance with claim 13 wherein:
said storage manager comprises an SQL database manager.

17. An application firewall machine in accordance with claim 13 wherein:
said storage manager comprises an indexed file system storage.

18. An application firewall machine in accordance with claim 13 wherein:
said storage manager comprises a file system storage.

19. An application firewall machine in accordance with claim 13 wherein:
said storage manager comprises distributed file system storage.

20. An application firewall machine in accordance with claim 10, further comprising:
an alerting interface operable to alerts an administrator through a notification channel, if said analysis determines that said command is not characteristic of a normal application program;
whereby the alert allows the administrator to initiate a course of action that further protects said manager. If said analysis determines that said command is not characteristic of a normal application program, said alerting interface

21. An application firewall machine in accordance with claim 17 wherein:
said alerting interface may send information about said attack to a destination selected from the group consisting of an SMTP servers, SNMP managers, system log files, and wireless pager notification.
